(19) United States
(12) Patent Application Publication
(10) Pub. No.: US 2026/0289131 A1
(43) Pub. Date: Sep. 24, 2026

(54) SYSTEM

(71) Applicant: SoftBank Group Corp., Tokyo (JP)

(72) Inventor: Keigo HIROKAWA, Tokyo (JP)

(73) Assignee: SoftBank Group Corp., Tokyo (JP)

(21) Appl. No.: 19/567,288

(22) Filed: Mar. 16, 2026

(30) Foreign Application Priority Data
Mar. 19, 2025 (JP) 2025-045124

(51) Int. Cl. G06F 40/295; G06F 40/166; G06F 40/205; G06F 40/284; G06F 40/40; G06N 20/00; G06V 30/19

(52) U.S. Cl. CPC G06F 40/295; G06F 40/166; G06F 40/205; G06F 40/284; G06F 40/40; G06N 20/00; G06V 30/19

(57) ABSTRACT

A system includes a processor that is configured to read, from election bulletins, policies and pledges asserted by respective candidates as digital text by using optical character recognition, classify the read policies and pledges based on specific keywords or categories by using natural language processing, and input a prompt to a generative AI model in order to instruct the generative AI model to generate an answer based on the classified policies and pledges.

### CROSS-REFERENCE TO RELATED APPLICATION

This application is based on and claims priority under 35 USC 119 from Japanese Patent Application No. 2025-045124 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for providing election information to voters generally rely on manually prepared summaries or simple keyword search over static digital documents. In such systems, policies and pledges asserted by respective candidates in election bulletins are often not digitized in a structured manner, and even when digital text is available, it is not consistently classified or organized according to issues, keywords, or categories. As a result, a voter cannot easily obtain a comprehensive and comparative understanding of candidates' positions on specific issues, such as taxation, welfare, or education, without reading and manually comparing entire bulletins.

Furthermore, although generative AI models are capable of producing natural-language answers, existing approaches typically do not provide a systematic mechanism for: (i) acquiring policies and pledges from election bulletins using optical character recognition, (ii) classifying the acquired text using natural language processing based on specific keywords or categories, and (iii) generating prompts that reliably constrain the generative AI model to base its answers on such structured and classified information. Conventional systems also insufficiently address the problem of adjusting the interaction with the generative AI model in response to a voter's sentiment or emotional state, which may lead to answers that are not appropriately phrased or are insufficiently tailored to the voter's needs.

Accordingly, there is a need for a system that automatically reads policies and pledges from election bulletins, classifies those policies and pledges according to specific keywords or categories, and generates prompts to a generative AI model in a way that produces accurate, organized, and context-appropriate answers for voters, including answers that are adapted based on sentiment analysis.

### SUMMARY

In order to solve the above-described problems, the present invention provides a system comprising a processor, wherein the processor is configured to read, from election bulletins, policies and pledges asserted by respective candidates as digital text by using optical character recognition, classify the read policies and pledges based on specific keywords or categories by using natural language processing, and input a prompt to a generative AI model in order to instruct the generative AI model to generate an answer based on the classified policies and pledges.

In one aspect, the processor is configured to obtain election bulletins corresponding to one or more candidates, execute optical character recognition on at least a portion of each bulletin to convert printed or image-based text into digital text, and store the obtained digital text in association with candidate identifiers. The processor then applies natural language processing techniques, such as tokenization, part-of-speech tagging, named entity recognition, or text classification, to extract policies and pledges from the digital text and classify the extracted policies and pledges into one or more predefined keywords or categories, such as “tax,” “welfare,” “education,” or “environment.”

In another aspect, the processor is configured, in response to a question received from a voter, to generate a prompt based on information that has been organized in a form allowing listing and comparison, such as policies and pledges grouped or indexed by candidate and issue. The processor then inputs the generated prompt to the generative AI model so as to instruct the generative AI model to generate an answer that reflects the classified and organized policies and pledges relevant to the voter's question.

In a further aspect, the processor is configured to perform sentiment analysis on, for example, the voter's question, prior interactions, or contextual text, and to adjust the prompt to the generative AI model based on a result of the sentiment analysis. By modifying at least one of the content, tone, or level of detail in the prompt according to the detected sentiment, the processor inputs an adjusted prompt that instructs the generative AI model to generate a more appropriate answer in view of the voter's emotional state or expressed attitude. Through these configurations, the system of the present invention enables automatic acquisition, classification, and AI-based answer generation for election policies and pledges, thereby assisting voters in understanding and comparing candidates' positions.

The term “election bulletin” refers to an official document or publication issued in connection with an election, which describes one or more candidates and includes policies, pledges, or statements asserted by the candidates.

The term “candidate” refers to a person running for an elected office whose policies or pledges are described in an election bulletin or similar election-related document. The term “policy” refers to a statement, proposal, or plan asserted by a candidate that indicates an intended course of action or position on a political, social, economic, or other public issue.

The term “pledge” refers to a promise, commitment, or assurance made by a candidate in relation to an action, reform, or outcome that the candidate intends to pursue if elected. The term “optical character recognition” refers to a technique or process for automatically detecting and converting characters contained in an image, scanned document, or non-text digital file into machine-readable digital text.

The term “digital text” refers to character data stored or processed in an electronic form that can be read, searched, or manipulated by a computer or processor.

The term “natural language processing” refers to a set of computational techniques for analyzing, interpreting, and processing human language text, including but not limited to tokenization, parsing, classification, and semantic analysis.

The term “keyword” refers to a word or phrase used as a basis for categorizing, indexing, or retrieving policies and pledges according to particular issues or topics.

The term “category” refers to a predefined class, label, or issue type, such as “tax,” “welfare,” or “education,” to which one or more policies or pledges can be assigned based on their content.

The term “classification” refers to the process of assigning one or more keywords or categories to a piece of text, such as a policy or pledge, based on its meaning or content.

The term “generative AI model” refers to a machine learning model configured to generate natural-language text output, such as an answer or explanation, in response to input data including prompts or instructions.

The term “prompt” refers to a text or structured input provided to a generative AI model, which specifies context, constraints, or instructions for generating an answer or other natural-language output.

The term “answer” refers to a natural-language text output generated by the generative AI model, which is intended to respond to a question from a voter or to provide information about candidates' policies or pledges.

The term “voter” refers to a person eligible or intending to participate in an election, who interacts with the system to obtain information about candidates and their policies or pledges.

The term “question” refers to a natural-language inquiry, request, or prompt provided by a voter to obtain information, clarification, or comparison regarding candidates' policies or pledges.

The term “information organized in a form that allows listing and comparison” refers to data structures or representations in which policies and pledges are arranged, grouped, or indexed (for example, by candidate and issue) so that multiple candidates' positions can be easily listed side-by-side and compared.

The term “sentiment analysis” refers to a computational technique for determining an attitude, emotion, polarity, or affective state expressed in text, such as positive, negative, neutral, frustrated, or concerned.

The term “adjust the prompt” refers to modifying at least part of the content, structure, tone, or level of detail of a prompt provided to a generative AI model, for example in response to a result of sentiment analysis.

The term “more appropriate answer” refers to an answer whose content, tone, and level of detail are better aligned with a voter's needs, context, or emotional state than an answer generated without such adjustment.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

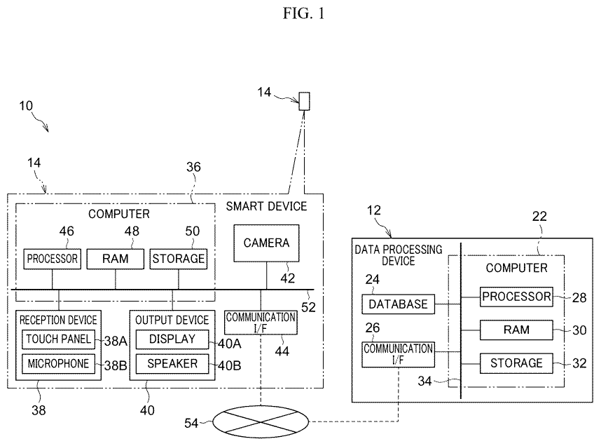

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

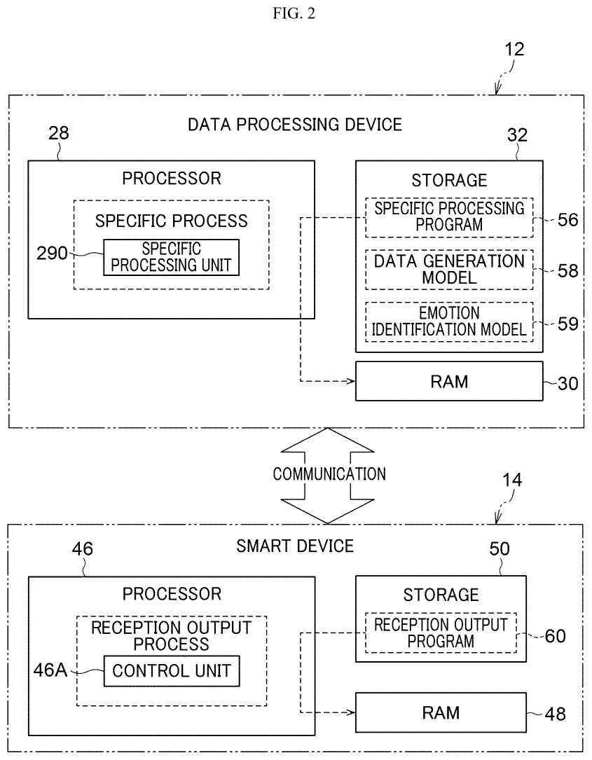

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented election information systems mainly provide simple keyword search and document browsing functions over digitized election materials. In such systems, a processing unit typically indexes text and returns passages that match user-entered keywords. However, these systems exhibit several technical limitations when applied to large volumes of heterogeneous election documents, such as manifestos, speeches, and policy brochures.

First, conventional systems do not automatically structure unformatted text into machine-usable units that explicitly associate each sentence with a particular candidate, an issue category, and a semantic type (for example, policy versus promise). As a result, downstream processing components and user interfaces are forced to repeatedly scan and filter the same unstructured text, leading to redundant computations, increased memory usage, and latency when responding to interactive queries from user terminals.

Second, in typical architectures, any attempt to integrate a generative AI model is performed in an ad hoc manner, by simply sending large blocks of raw or lightly processed text as input. Such usage places a heavy load on network bandwidth and on the generative AI model, increases inference time, and often produces non-deterministic or incomplete answers, because the model is not guided by a system-level representation of candidate-issue-statement relationships. This results in inefficient utilization of computational resources and poor controllability over the form and content of generated answers.

Third, known systems do not provide a standardized, processor-level mechanism for generating prompt sentences based on structured, issue-specific comparison data. Without such a mechanism, a computing device cannot reliably direct a generative AI model to perform targeted comparative analysis (for example, comparing only education-related promises across candidates), and cannot systematically control output style (such as neutrality, readability, or comparison viewpoints). Consequently, the processor cannot fully leverage the generative AI model as a deterministic component in an information processing pipeline.

Fourth, when a user requests comparison across multiple candidates on selected issues, conventional systems execute multiple independent search operations on unstructured text each time, which leads to repeated text parsing, repeated issue detection, and repeated candidate identification. This architecture fails to exploit pre-computed structured data, and therefore scales poorly as the number of candidates, documents, and user queries increases. Therefore, there is a need for a computer-implemented system and server-side processing architecture that (i) normalizes raw election-related electronic files into structured data associating candidates, issues, and statement types, (ii) manages such structured data in a database for efficient candidate-by-issue retrieval, and (iii) automatically generates prompt sentences for a generative AI model based on this structured representation. Such a system should reduce redundant natural language processing at query time, improve the efficiency and determinism of answer generation, and technically enhance the overall election information processing pipeline from data ingestion through generative output.

The specific processing by the specific processing unit 290 of the data processing device 12 in Example 1 is realized by the following means.

The present invention provides a server comprising a processor configured to acquire, via an input interface, electronic files including election-related information from user terminals; to analyze formats of the electronic files and to extract text information therefrom; to normalize the extracted text information by removing unnecessary symbols and whitespace; to perform natural language processing on the normalized text in order to detect expressions indicating candidates, to specify speaking subjects based on the detected expressions, and to extract, for each speaking subject, sentences corresponding to policies or promises; to classify the extracted sentences into issue classifications and type classifications according to classification rules or trained classification models and to generate structured data representing association information between candidates and issue classifications; to store and manage the structured data in a database such that the structured data is searchable by candidate and by issue classification; to retrieve, in response to user selections, policies or promises of a plurality of candidates on an issue-by-issue basis from the structured data and to generate comparison information in a list-comparable format for display on the user terminals; and to generate, based on at least one of the structured data and the comparison information, prompt sentences to be input to a generative AI model so as to instruct the generative AI model to generate answers related to the policies or promises of the candidates. This enables the server to convert heterogeneous election-related electronic files into a unified, structured representation optimized for machine processing, to serve user requests by performing efficient database queries instead of repeated raw text analysis, and to invoke a generative AI model through systematically constructed prompt sentences that leverage pre-computed candidate-issue-statement relationships, thereby reducing computational redundancy, improving response latency and scalability, and providing more controllable and reliable generated answers in a computer-implemented election information processing environment.

The term “electronic file” refers to a data object stored in a non-transitory computer-readable medium, including but not limited to a document file, an image file, or a text file, that contains election-related information and is capable of being transmitted from a user terminal to a server.

The term “election-related information” refers to information associated with an election process, including, for example, policies, promises, statements, or other textual content describing positions or pledges of candidates.

The term “user terminal” refers to a computing device operated by a user, such as a personal computer, a smartphone, a tablet, or another communication device, that is configured to transmit electronic files and display information received from a server.

The term “input device” refers to a hardware or software interface, including, for example, a network interface, a web server interface, or an application programming interface, through which a server acquires electronic files or other data from a user terminal.

The term “normalized text” refers to text data that has been processed from raw extracted text by operations such as removing unnecessary symbols, whitespace, and control characters, and optionally applying character normalization, so as to provide a consistent representation suitable for natural language processing.

The term “natural language processing technology” refers to a set of computer-implemented methods and algorithms configured to analyze human language text, including, for example, tokenization, sentence segmentation, part-of-speech tagging, named entity recognition, and text classification.

The term “expression indicating a candidate” refers to a word, phrase, or other linguistic unit appearing in text that denotes or refers to a particular candidate in an election, and that can be used by a processor to identify a speaking subject.

The term “speaking subject” refers to an entity, such as a candidate, that is determined, based on textual context and expressions indicating the candidate, to be the originator or declarant of a sentence or statement in election-related text.

The term “policy” refers to a statement in election-related text that expresses a plan, principle, or course of action proposed or advocated by a candidate.

The term “promise” refers to a statement in election-related text that expresses a commitment, pledge, or declared intention by a candidate to perform a specific action or to implement a specific measure.

The term “issue classification” refers to a category label assigned to a sentence or statement that represents a particular election-related topic or issue, such as education, healthcare, or economy, and that is used to organize and retrieve statements by topic.

The term “type classification” refers to a label assigned to a sentence or statement indicating whether the sentence or statement is of a particular type, including, for example, a policy type or a promise type.

The term “classification rule” refers to a predetermined set of logical conditions, patterns, or keyword-based criteria that a processor applies to text in order to assign one or more classifications, such as issue classifications or type classifications.

The term “trained classification model” refers to a machine-learned model, generated by training on labeled textual data, that is configured to automatically assign one or more classifications to input sentences or statements.

The term “structured data” refers to data that has been organized into a predefined schema or format, such as records or fields, that explicitly associate candidates, issue classifications, type classifications, and corresponding sentences or statements.

The term “association information” refers to information that links or correlates multiple entities, such as candidates, issue classifications, and sentences, in a manner that allows retrieval and processing based on such relationships.

The term “database management device” refers to a computing component, including a database management system and associated storage, that stores, indexes, and retrieves structured data in response to queries from a processor.

The term “comparison information” refers to information derived from structured data that arranges policies or promises of multiple candidates in a format that facilitates side-by-side or list-based comparison on an issue-by-issue basis.

The term “list-comparable format” refers to a data arrangement, such as a table or structured list, in which policies or promises of multiple candidates are organized by issue classification so that a user can visually or programmatically compare the statements across candidates.

The term “prompt sentence” refers to a text string or set of text strings generated by a processor for input to a generative AI model, the text string including instructions or contextual information that guide the generative AI model in producing an answer.

The term “generative information processing model” refers to a computational model, such as a generative AI model, that is configured to generate natural language output based on an input prompt, and that can produce explanations, summaries, or comparisons of election-related policies or promises.

The term “template” refers to a predefined text pattern or structure including variable portions into which data such as candidate identifiers, issue classifications, and representative sentences can be inserted to generate a complete prompt sentence.

The term “string operation” refers to a computer-implemented manipulation of character sequences, including concatenation, insertion, replacement, or formatting, used to assemble or modify text such as prompt sentences.

The term “representative sentence” refers to a sentence selected from among multiple sentences associated with a candidate and an issue classification, which sentence is deemed, based on a rule or scoring criterion, to best represent the candidate's policy or promise for that issue.

The term “contextual information” refers to supplementary text, including, for example, representative sentences, candidate identifiers, and issue classifications, that is embedded into a prompt sentence to provide context for a generative information processing model.

The term “candidate identifier” refers to information, such as a name, label, or code, that uniquely distinguishes one candidate from another within structured data and is used to associate sentences or statements with the corresponding candidate.

The term “neutral and user-friendly explanatory format” refers to a style of generated text that is configured to be unbiased, clear, and easily understandable by a general user, without favoring any particular candidate or viewpoint.

The term “comparison viewpoint” refers to a specified aspect or criterion, such as budget impact, target population, or implementation timeline, that a generative information processing model is instructed to address when comparing policies or promises.

The term “output style” refers to a specified formatting or rhetorical style of generated answers, including, for example, bullet-point format, paragraph format, or summarized comparison format, as directed by the prompt sentence.

In one embodiment, a server cooperates with one or more terminals operated by users to implement the claimed system. The server includes at least one processor, a memory storing program code and models, and a non-transitory storage device storing structured data and logs. The server is connected to a communication network via a network interface. The terminal includes a display device, an input device, a communication interface, and a browser or dedicated application. The user operates the terminal to provide election-related electronic files and to view comparison information and generated explanations.

The server executes an operating system such as a general-purpose server operating system and runs an application framework such as a web application framework. The server uses a natural language processing library such as an NLP toolkit, a PDF parsing library such as a PDF text extraction toolkit, and a document parsing library such as a word processing file parser. The server uses a relational database management system, such as a generic SQL database management system, to store and manage structured data. The server further uses a machine learning framework, such as a deep learning library, to execute a generative AI model and one or more classification models.

The server stores a generative AI model implemented as a transformer-based neural network. The generative AI model includes an embedding layer that maps tokens to embedding vectors, a plurality of self-attention layers with multi-head attention, feed-forward layers, layer normalization components, and an output layer that produces probability distributions over a vocabulary. The server also stores at least one text classification model, which may be a fine-tuned transformer encoder model that outputs a vector representation for an input sentence and applies one or more linear layers with a softmax activation to produce an issue classification and a type classification (policy versus promise).

The server trains or fine-tunes the classification model by using labeled training data consisting of sentences extracted from historical election documents. For each training sample, the server stores a sentence, a label indicating an issue category (for example, education, healthcare, economy) and a label indicating a type (policy or promise). The server uses a cross-entropy loss function over the classification outputs and updates the model weights by gradient-based optimization, such as stochastic gradient descent or an adaptive gradient method. The server uses data augmentation techniques such as synonym replacement, sentence paraphrasing, or back-translation to improve robustness of the classifier to linguistic variation. During training, the server stores model checkpoints and validation metrics to select a model with improved accuracy.

The server stores a rule-based classifier as an alternative or complementary component to the trained classification model. The rule-based classifier is implemented with pattern-matching rules and keyword lists. For example, the server stores, in a configuration file, sets of keywords for each issue classification, and stores pattern templates for promises such as “will [verb]”, “plan to [verb]”, “promise to [verb]”, and their equivalents in the relevant language. The server uses an NLP library's pattern-matching engine to detect occurrences of such patterns and to assign preliminary type labels. The server then combines outputs of the rule-based classifier and the trained classification model, for example by computing a weighted score or by selecting the label with higher confidence, to obtain a final classification.

The server stores a data schema in the database. In one embodiment, the schema includes a candidate table, an issue table, and a statement table. The candidate table includes fields such as a candidate identifier, a name string, and a reference to an election identifier. The issue table includes fields such as an issue identifier and an issue name string. The statement table includes fields such as a statement identifier, a candidate identifier, an issue identifier, a type field indicating a policy or a promise, a text field storing the sentence, a source file identifier, a position index within the source file, and one or more confidence scores. The server creates indexes over candidate identifiers and issue identifiers to reduce query time when retrieving statements for comparison.

The server receives an electronic file from the terminal through an HTTP or HTTPS connection. The electronic file may be a PDF document, a word processing document, or a plain text file. The server uses a PDF text extraction toolkit when the electronic file is a PDF, and a word processing file parser when the electronic file is a word processing document. The server reads the bytes of the electronic file into memory, uses a file format detection routine to determine the type, and invokes the appropriate library to extract page text or paragraph text from the file. The server then converts the extracted text into normalized text by applying character encoding normalization, removing control characters and extraneous whitespace, and standardizing line break representation.

The server applies a sentence segmentation algorithm provided by the NLP library to segment the normalized text into sentences. The server then applies tokenization to split each sentence into tokens and applies part-of-speech tagging and named entity recognition. The server detects expressions indicating candidates by recognizing person entities or by matching the text against a list of candidate names stored in the database. The server uses a context window to determine a speaking subject: when a candidate name appears at the beginning of a paragraph or is marked as a speaker, the server maintains that candidate as the active speaking subject for subsequent sentences until another candidate is detected. The server records, for each sentence, a candidate identifier or a default identifier indicating that the candidate is not determined.

The server applies the classification model and rule-based classifier to each sentence. For each sentence, the server converts the tokens into embedding vectors, passes them through the transformer encoder layers, and obtains a sentence representation from a designated pooling mechanism such as a [CLS] token representation or an average over token embeddings. The server applies one or more linear layers with a softmax activation to obtain a probability distribution over issue classes and a probability distribution over type classes. The server then applies rule-based pattern matching using stored keyword lists and grammatical patterns. For example, when the server detects modal constructions indicating commitments, the server increases the weight for the promise class. The server combines the model outputs and the rule-based results to obtain a final issue classification and type classification. The server discards sentences classified as neither policy nor promise.

The server generates a structured record for each remaining sentence. The server assigns the candidate identifier, the issue identifier, the type label, and the text of the sentence to fields in the statement table. The server additionally stores a confidence score computed from the classification probabilities and rule-based signals. The server inserts these records into the database via an object-relational mapping library or direct SQL commands. This database representation allows the server to avoid re-running expensive natural language processing on the same documents for subsequent queries, thereby improving processing speed and reducing computational load.

The server generates comparison information by retrieving structured data from the database. When the user specifies an issue such as education, healthcare, or transportation at the terminal, the terminal sends the selected issue identifier to the server. The server executes a database query to fetch all statements whose issue identifier matches the selection. The server groups statements by candidate identifier and may select representative sentences for each candidate. For example, the server can compute a relevance score based on a combination of confidence score, sentence length, and position in the original document, and select the top-ranked sentences as representative sentences. The server constructs a comparison data structure in memory, for example a table with an issue row and candidate columns, each cell containing one or more representative sentences. The server sends this comparison information to the terminal, where the terminal renders the information in a table or list format.

The server generates prompt sentences for a generative AI model by using templates and string operations. The server stores prompt templates as text patterns with placeholders for candidate identifiers, issue names, and representative sentences. For example, for education reform, the server may produce a prompt sentence such as:
“You are an assistant helping voters understand candidates' policies.

Below is structured information about the education-related promises of each candidate in the upcoming city mayoral election.

### Candidate A:

Promise: Increase the city's education budget by 20% over the next four years.
Promise: Introduce a scholarship program for low-income students.

### Candidate B:

Promise: Reduce class sizes in public elementary schools.
Promise: Provide free after-school tutoring.

Please summarize and compare these education promises in clear, neutral language. Focus on how the promises differ in terms of budget, access, and support measures for students. Explain your answer so that a general voter without specialized knowledge can easily understand.”

The server can also generate a prompt sentence for transportation policies such as:
“Using the following extracted transportation policies from the city mayor election database, compare the candidates' approaches:

### Candidate A:

Policy: Extend subway line 2 to the northern residential area by 2030.

### Candidate B:

Policy: Introduce new bus routes connecting suburbs to downtown.
Policy: Reduce bus fares for seniors and students.

Provide a voter-friendly comparison that highlights the main differences in scope, timeline, and targeted beneficiaries.”

The server performs string operations such as concatenation and placeholder substitution using a template engine or string formatting functions to generate the final prompt text. The server then passes this prompt sentence to the generative AI model either by internal function calls, when the model is hosted on the same server, or by forming an HTTP request to a model-serving endpoint.

The server controls the behavior of the generative AI model by including explicit instructions in the prompt sentence. The server specifies that the answer must be neutral, must explain differences and commonalities across candidates, and must adopt a particular output style such as bullet points or concise paragraphs. By embedding structured context and explicit constraints in the prompt, the server shapes the internal attention patterns and token probability distributions of the generative AI model, resulting in more deterministic and relevant outputs compared to naive usage that simply transmits unstructured text.

The server improves computer technology in multiple ways. First, the server reduces repeated parsing and classification by transforming raw election-related electronic files into structured data once and reusing this representation for future queries. This reduces CPU usage and memory consumption, and improves response time under high query volume. Second, the server reduces network traffic and model computation by generating compact prompt sentences that include only relevant, pre-selected representative sentences, rather than transmitting entire source documents or redundant content to the generative AI model. Third, the server improves accuracy and consistency by combining machine-learned classification with rule-based processing tailored to election language, which results in more reliable identification of policies and promises than manual human scanning or naive keyword search. The server also performs operations that are not mere automation of human reading. The server uses non-intuitive combinations of neural classification and rule-based scoring to assign issue and type classifications. The server uses structured data to pre-compute candidate-issue relationships and exploits database indexing structures to achieve logarithmic-time retrieval behavior. The server configures the generative AI model as a component within an optimized data pipeline, where prompt sentences are programmatically assembled from pre-structured information rather than generated on an ad hoc basis by human operators.

The system can be implemented in variants. In one variant, the terminal runs a native application instead of a browser, but the communication and data structures remain similar. In another variant, the server deploys the generative AI model locally, using a hardware accelerator such as a graphics processing device or tensor processing device for matrix multiplications in the transformer layers. In yet another variant, the server replaces the transformer-based classifier with a convolutional neural network classifier or a recurrent neural network classifier for issue and type classification, while preserving the overall data flow of extracting, normalizing, classifying, structuring, and prompting.

The server can also support multilingual election documents by storing different language-specific models and switching models based on detected language of the input electronic file. The server can further compress or cache intermediate representations to reduce memory footprint. For example, the server can store hashed fingerprints of sentences and check for duplicates before re-running classification.

By combining these hardware and software components, the server, the terminal, and the user cooperate such that the system provides a technical improvement in how election-related text data is ingested, normalized, structured, stored, retrieved, and used to drive a generative AI model. The structured representation and prompt generation mechanisms allow the generative AI model to operate as part of a technically improved computing system, with reduced processing time, improved accuracy, and controlled output format, rather than as a generic black-box text generator.

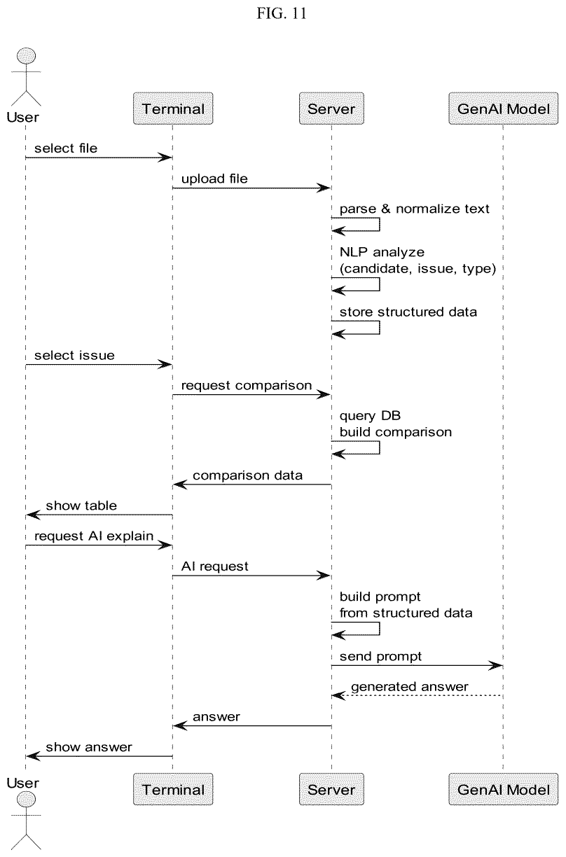

The following describes the processing flow using FIG. 11.

### Step 1:

User operates the terminal to select an election-related electronic file and request upload. User views an upload screen on the terminal and chooses a local file (for example, a manifesto document) using a file selection dialog. The input of this step is a file path or file object on the terminal's storage. Terminal reads the file bytes via the operating system's file I/O and attaches the file to an HTTP or HTTPS request using a multipart/form-data format. The output of this step is an HTTP or HTTPS request containing the electronic file data sent from the terminal to the server.

### Step 2:

Server receives the electronic file and stores it in temporary storage.

Server accepts the HTTP or HTTPS request via a web server component and passes the file stream to an application framework. The input of this step is the uploaded file stream contained in the network request. Server writes the file bytes to a temporary location on a non-transitory storage device and records metadata such as original file name, file size, content type, and upload timestamp. The output of this step is a stored electronic file and associated metadata available for subsequent processing.

### Step 3:

Server determines the file format and extracts raw text from the electronic file.

Server reads the stored file and analyzes its extension and content type to classify the file as a PDF, word processing document, plain text file, or other format. The input of this step is the stored electronic file and its metadata. Server invokes a corresponding parsing library; for example, the server uses a PDF parsing component for PDF files or a word processing document parser for word processing formats to extract page text or paragraph text. The server concatenates extracted units into a single raw text string. The output of this step is a raw text representation of the election-related content.

### Step 4:

Server normalizes the extracted text to generate normalized text suitable for language analysis.

Server takes the raw text as input and applies character encoding normalization, whitespace normalization, and symbol filtering. The input of this step is the raw text string. Server removes control characters, converts multiple line breaks into single line breaks, trims leading and trailing spaces, and optionally converts variant forms of characters into canonical forms. The server may also strip repeated headers and footers by detecting recurring patterns. The output of this step is normalized text that is cleaner and more consistent than the raw text.

### Step 5:

Server segments the normalized text into sentences and performs basic linguistic annotation. Server uses a natural language processing library to split the normalized text into individual sentences and to tokenize each sentence into words and punctuation marks. The input of this step is the normalized text string. Server applies sentence segmentation algorithms, tokenizers, part-of-speech taggers, and named entity recognition models to produce token sequences, grammatical tags, and entity labels. The output of this step is a collection of sentence objects, each containing token information, linguistic annotations, and entity detection results.

### Step 6:

Server detects candidate expressions and assigns a speaking subject to each sentence. Server examines the annotated sentences and identifies occurrences of person entities or known candidate names stored in a candidate list. The input of this step is the set of annotated sentences and a list of candidate identifiers and names. Server maintains a current speaker context: when a sentence clearly names a candidate as a speaker, server updates the context; for subsequent sentences lacking explicit names, server assigns the current context as the speaking subject. Server associates each sentence with a candidate identifier or a default identifier indicating unknown speaker. The output of this step is a set of sentences each linked to a speaking subject.

### Step 7:

Server classifies sentences as policy, promise, or other using rule-based and model-based processing.

Server applies a trained classification model and rule-based patterns to each sentence. The input of this step is the set of sentences associated with speaking subjects, along with their tokens and annotations. Server converts tokens into numerical embeddings, passes them through a neural classification model to obtain predicted probabilities for policy, promise, and other classes, and concurrently evaluates rule-based patterns such as “will [verb]” or “plan to [verb]”. Server combines probabilities and rule outputs to assign a final type label and a confidence score to each sentence. The output of this step is a filtered list of sentences labeled as policy or promise, each with a type label and confidence value.

### Step 8:

Server assigns issue classifications to policy and promise sentences.

Server uses an issue classifier to map each policy or promise sentence to an issue category such as education, healthcare, or economy. The input of this step is the list of labeled policy and promise sentences and a set of issue categories with associated models or keyword lists. Server applies a multi-class text classifier or rule-based keyword matching to compute a probability distribution over issue classes, selects the highest-probability class as the issue classification, and optionally records the probability as an issue confidence score. The output of this step is a set of statements, each associated with a candidate identifier, a type label, and an issue classification.

### Step 9:

Server constructs structured data records and stores them in a database.

Server formats each classified statement into a record with fields for candidate identifier, issue identifier, type label, sentence text, source file identifier, document position, and confidence scores. The input of this step is the set of classified statements and the database schema definitions. Server performs database operations such as insert or update through a database management interface, writes the records into a statement table, and maintains indexes on candidate and issue fields. The output of this step is a structured dataset stored in a database, enabling efficient search by candidate and issue.

### Step 10:

User specifies one or more issues for comparison via the terminal interface.

User interacts with a selection interface on the terminal, such as dropdown menus or checkboxes representing available issues. The input of this step is the list of issues displayed on the terminal. User selects one or more issues of interest and triggers a comparison request. Terminal packages the selected issue identifiers into a request payload and sends the payload to the server over the network. The output of this step is an issue selection request transmitted from the terminal to the server.

### Step 11:

Server retrieves candidate statements matching the selected issues and builds comparison data.

Server receives the selection request containing issue identifiers and queries the database for statements whose issue identifiers match the selection. The input of this step is the issue selection request and the structured data stored in the database. Server groups the retrieved statements by candidate and issue, optionally ranks statements by confidence or relevance, and selects one or more representative sentences for each candidate-issue pair. Server assembles the selected sentences into a comparison data structure organized by issue and candidate. The output of this step is a structured comparison dataset ready for rendering or prompt generation.

### Step 12:

Terminal displays the comparison dataset to the user in a list-comparable format.

Terminal receives the comparison dataset from the server and converts the data into a visual layout, such as a table where rows correspond to issues and columns correspond to candidates. The input of this step is the comparison dataset containing candidate identifiers, issue identifiers, and representative sentences. Terminal creates visual elements for each issue and candidate cell, inserts the representative sentences into the cells, and renders the interface on the display. The output of this step is a visual comparison view presented to the user, enabling side-by-side inspection of policies and promises.

### Step 13:

User requests an explanation or summary generated by a generative AI model for selected issues.

User observes the comparison view and may wish to obtain a more digestible explanation of differences and commonalities among candidates. The input of this step is the displayed comparison information. User activates a control such as a “Explain with AI” button and optionally enters a natural language question, for example, “Explain the differences in education policies in simple terms.” Terminal collects the selected issue identifiers and the user's question and sends them to the server within a request message. The output of this step is an AI explanation request transmitted to the server.

### Step 14:

Server prepares contextual information from structured data for prompt sentence generation. Server receives the AI explanation request and identifies the selected issues and the relevant candidates. The input of this step is the AI explanation request and the structured data stored in the database. Server queries the database to retrieve statements for each candidate under the selected issues and selects representative sentences using criteria such as highest confidence or diversity of content. Server formats these sentences into candidate-specific bullet lists or short summaries, thereby constructing contextual information to be embedded into a prompt. The output of this step is a structured context object containing candidate names, issue descriptors, and representative sentences.

### Step 15:

Server generates a prompt sentence for a generative AI model using templates and string operations.

Server loads a predefined prompt template corresponding to the type of explanation requested, such as comparison or summary. The input of this step is the structured context object and the prompt template. Server inserts candidate names, issue descriptions, and representative sentences into placeholders in the template and appends explicit instructions regarding neutrality, level of detail, and comparison viewpoints. For example, server may generate a prompt sentence such as:
“You are an assistant helping voters understand candidates' policies.

Below is structured information about the education-related promises of each candidate in the upcoming city mayoral election.

### Candidate A:

Promise: Increase the city's education budget by 20% over the next four years.
Promise: Introduce a scholarship program for low-income students.

### Candidate B:

Promise: Reduce class sizes in public elementary schools.
Promise: Provide free after-school tutoring.

Please summarize and compare these education promises in clear, neutral language. Focus on how the promises differ in terms of budget, access, and support measures for students. Explain your answer so that a general voter without specialized knowledge can easily understand.”

The output of this step is a finalized prompt sentence ready for submission to the generative AI model.

### Step 16:

Server submits the prompt sentence to a generative AI model and receives a generated answer.

Server sends the prompt sentence to a generative AI model implemented locally or accessible via a model-serving endpoint. The input of this step is the prompt sentence generated in the previous step. Server feeds the prompt into the generative model's input interface, which processes the text and produces an output sequence representing a natural language answer. Server receives the generated answer text and may perform optional post-processing such as trimming or formatting. The output of this step is an explanation or comparison text generated by the generative AI model.

### Step 17:

Terminal presents the generated answer to the user and enables further interaction.

Terminal accepts the generated answer text from the server in an HTTP or HTTPS response. The input of this step is the answer text produced by the generative AI model. Terminal inserts the answer into a designated area of the user interface, for example below the comparison table, and displays it in a readable format. Terminal may provide controls for the user to request additional clarifications, focus on another issue, or refine the question. The output of this step is an updated screen in which the user can read the AI-generated explanation in conjunction with the underlying comparison data.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for providing election-related information to voters generally focus on presenting raw or lightly formatted text, such as full election bulletins or static candidate profiles. In such systems, a processor typically performs only basic text digitization and keyword search, and therefore fails to transform unstructured document data into machine-usable, issue-centric structures that support efficient computation, comparison, and adaptive explanation. As a result, the underlying computer technology is not effectively leveraged to handle large-scale election documents in a way that optimizes data retrieval, processing, and presentation for interactive use.

First, conventional systems often store digitized election documents as flat text or simple records without robust, issue-based structuring. In these systems, a storage device and database engine are used in a generic manner, merely indexing entire documents or simple metadata. This results in inefficient query execution when users seek to compare specific policies across multiple candidates and issues, because the processor must repeatedly scan or post-process large text segments at query time. The lack of structured, per-candidate, per-issue policy data also prevents the system from performing fine-grained retrieval operations and optimized indexing strategies that would reduce processing load and latency.

Second, existing systems do not integrate natural language processing pipelines with generative models in a way that systematically prepares structured data and dynamic prompts for issue-focused comparison. While generative models can be called as generic text generators, the prompts are typically ad hoc and not coupled to a structured data layer. As a consequence, the computing resources of the generative model and host server are not efficiently utilized, and the model may process irrelevant or redundant text, increasing computational cost, latency, and response variability. Furthermore, known approaches do not treat prompt generation and model invocation as integral parts of a data processing pipeline that transforms unstructured documents into structured, indexable, and model-ready representations.

Third, conventional user interfaces and back-end processing pipelines do not adapt the content generation process to the user's comprehension level or interest as inferred from interaction data. Although some systems may track basic usage metrics, they do not perform systematic sentiment analysis or behavior analysis to control the level of detail, style, or focus of generated explanations. Consequently, the computer system delivers static, one-size-fits-all responses that can overload less experienced users with excessive technical detail or under-inform expert users, resulting in suboptimal use of computing resources for content generation and presentation.

Fourth, existing election information systems lack an integrated mechanism for list-comparable formatting of policies at the server side, based on structured policy records and index information, prior to transmission to a terminal. In many cases, the computing task of structuring and aligning candidate policies is pushed to the client or is left to manual user inspection. This leads to repeated, redundant processing across clients, inefficient use of network bandwidth, and increased latency in multi-candidate, multi-issue comparison tasks. The absence of a server-side representation specifically tailored for cross-candidate comparison prevents the system from optimizing both database retrieval and subsequent generative processing over precisely the relevant subset of data.

Accordingly, there is a need for a computer-implemented system that improves the functioning of the underlying computer technology by: (i) transforming election-related document images and text into normalized, structured, and indexed per-candidate, per-issue policy data suitable for efficient retrieval; (ii) automatically generating prompt sentences for a generative model based on this structured data and user queries, so that the model processes only relevant, pre-structured information; (iii) dynamically adjusting prompts and responses based on sentiment and interaction analysis to optimize the amount and style of information delivered; and (iv) generating, at the server, list-comparable, issue-centric formats that are efficiently transmitted to a terminal device. Such a system would reduce processing redundancy, lower query latency, and more effectively utilize storage, database, and generative model resources to provide interactive, comparative election information in a technically improved manner.

The specific processing by the specific processing unit 290 of the data processing device 12 in Application Example 1 is realized by the following means.

The present invention provides a server comprising a processor and a memory storing instructions that, when executed by the processor, cause the processor to acquire candidate assertion information as electronic character information from election-related document information using image recognition processing and character recognition processing; to analyze the acquired electronic character information using natural language processing to perform syntactic analysis and semantic analysis, to extract policy information for each candidate, and to record the policy information as structured data based on classification information and search information associated with issues of public concern; to store the structured data in a relational information management device and to generate index information associated with candidate information, issue information, and policy information; to retrieve, based on issue designation information or candidate designation information received from an information terminal device, corresponding policy information from the relational information management device, to format the policy information into a list-comparable format by candidate or by issue, and to transmit the formatted policy information to the information terminal device; to automatically generate a prompt sentence to be input to a generative information processing model on the basis of the structured data and question information acquired from a user, and to instruct the generative information processing model to execute response generation processing; and to associate response information acquired from the generative information processing model with display information for presenting the response information together with the list-comparable format, and to transmit the associated information to the information terminal device. This enables the computer system to transform unstructured election-related document data into structured, indexed, and comparison-ready representations, to generate and adapt prompt sentences and responses in a manner that optimizes use of database, processing, and generative model resources, and to deliver efficiently retrievable, issue-centric, and user-tailored comparative election information with improved latency, scalability, and usability.

The term “election-related document information” refers to document data associated with an election process, including but not limited to bulletins, announcements, policy statements, and candidate profiles, in image, text, or mixed media form, from which candidate assertions can be obtained.

The term “candidate assertion information” refers to information representing claims, policies, pledges, or positions expressed by a candidate in an election-related document, including textual segments that describe intended actions, goals, or commitments.

The term “image recognition processing” refers to computerized processing that analyzes image data to detect, segment, or identify regions or patterns, including but not limited to page layout detection, region-of-interest extraction, and separation of text and non-text elements.

The term “character recognition processing” refers to computerized processing that converts image-based character patterns into machine-readable character codes, including techniques such as optical character recognition applied to printed or handwritten text.

The term “electronic character information” refers to machine-readable character data obtained from document images or other sources, represented in a digital encoding format suitable for further computational processing and storage.

The term “natural language processing” refers to computerized techniques for analyzing and processing human language text, including but not limited to tokenization, part-of-speech tagging, syntactic analysis, semantic analysis, named-entity recognition, and text classification.

The term “syntactic analysis” refers to natural language processing that identifies grammatical structure in text, including relationships among words and phrases, such as subject, predicate, and modifiers, typically represented as parse trees or dependency structures.

The term “semantic analysis” refers to natural language processing that derives meaning-related information from text, including but not limited to entity roles, topic identification, intent detection, and semantic relationships among words, phrases, and sentences.

The term “policy information” refers to information extracted from candidate assertion information that describes specific measures, plans, rules, or intended actions related to public issues or governance.

The term “structured data” refers to data organized into a predefined format, such as records or fields, that associate candidate information, issue information, and policy information with explicit attributes and relationships suitable for storage in a database or similar data structure.

The term “classification information” refers to data that associates text or policy information with one or more categories, topics, or labels, such as issues of public concern, for the purpose of organizing and retrieving the information.

The term “search information” refers to data, such as keywords, index terms, or identifiers, that enables efficient retrieval of related records from a storage system in response to a query.

The term “issues of public concern” refers to topics or subject areas relevant to public policy or governance, including but not limited to environment, economy, taxation, education, healthcare, security, and social welfare.

The term “relational information management device” refers to a computing system or component that stores and manages structured data in accordance with a relational data model, including functionality for defining tables, fields, relationships, and indexes, and for executing queries.

The term “index information” refers to auxiliary data structures or metadata that associate keys or attributes with storage locations of records, enabling efficient lookup, retrieval, or sorting of candidate information, issue information, and policy information.

The term “candidate information” refers to data identifying and describing a candidate, including but not limited to a name, an identifier, an affiliation, a region, and any associated metadata.

The term “issue information” refers to data that identifies and characterizes an issue of public concern, including an issue name, an issue identifier, and optional descriptive attributes.

The term “information terminal device” refers to an electronic device operated by a user, such as a portable communication device, a wearable computing device, or a general-purpose computing device, that can send requests to and receive responses from a server over a communication network.

The term “issue designation information” refers to data transmitted from an information terminal device that specifies one or more issues of public concern to be used as conditions for retrieval or formatting of policy information.

The term “candidate designation information” refers to data transmitted from an information terminal device that specifies one or more candidates to be used as conditions for retrieval or formatting of policy information.

The term “list-comparable format” refers to a representation of policy information that aligns data across multiple candidates or issues in a structured, side-by-side or tabular manner, enabling direct visual and logical comparison of corresponding elements.

The term “prompt sentence” refers to a machine-generated or machine-processed textual instruction or input string that is provided to a generative information processing model to condition or guide the generation of a response.

The term “generative information processing model” refers to a computational model, such as a generative artificial intelligence model or large language model, that generates natural-language or structured outputs based on input text, prompts, or other contextual information.

The term “response generation processing” refers to computerized processing performed by a generative information processing model to produce response information, such as explanations, summaries, or comparisons, from a given prompt sentence and associated input data.

The term “response information” refers to information generated by a generative information processing model in response to a prompt sentence, including explanations, summaries, comparisons, or other content intended to be presented to a user.

The term “display information” refers to data defining how content, including response information and policy information, is to be visually or otherwise presented on an information terminal device, such as layout, grouping, ordering, or emphasis.

The term “question information” refers to data representing a query or request for information supplied by a user, typically in natural language, to be processed by the system and optionally by a generative information processing model.

The term “operation history information” refers to data representing a record of user interactions with an information terminal device or system, including but not limited to selections, inputs, navigation events, and timing information.

The term “sentiment analysis” refers to computerized analysis of text or interaction data to infer affective or attitudinal characteristics, such as emotional tone, polarity, frustration, confidence, or engagement level.

The term “expression style” refers to characteristics of generated text, including but not limited to tone, formality, complexity, conciseness, and use of technical or non-technical vocabulary.

The term “detail level” refers to the granularity or amount of information included in generated text, including the breadth, depth, and specificity of explanations, examples, and supporting details.

The term “comprehension level” refers to an estimated degree of a user's understanding or familiarity with a topic, inferred from question information, operation history information, or sentiment analysis.

The term “interest level” refers to an estimated degree of a user's engagement or concern with a topic, inferred from question information, operation history information, or sentiment analysis.

In one embodiment, a server implements the invention by executing a computer program stored in a non-transitory computer-readable medium on hardware including a central processing unit, a main memory, a persistent storage device such as a solid-state drive, and a network interface. The server runs an operating system such as a general-purpose server operating system (for example, a UNIX-like operating system) and application software implemented in a high-level programming language such as a scripting language or a compiled language. The server cooperates with one or more terminals operated by users, where each terminal is implemented as a smartphone, a tablet computer, a wearable display device, or a personal computer running a client application or a web browser.

The server acquires election-related document information by receiving electronic images or electronic text of election bulletins and similar documents. The server uses image recognition processing implemented by a computer vision library to detect page regions, locate textual blocks, and distinguish between text, images, and decorative elements. The server applies character recognition processing, such as optical character recognition, to the detected text regions. In one example, the server uses an optical character recognition engine that performs binarization, connected component analysis, character segmentation, and classification using a trained classifier. As a result, the server converts the election-related document information into electronic character information encoded in a character encoding format such as UTF-8. The server processes the acquired electronic character information by using a natural language processing pipeline implemented with a natural language processing library such as a syntactic parser and a semantic analyzer. The server performs tokenization to split text into tokens, performs part-of-speech tagging, and applies syntactic analysis to generate parse trees or dependency graphs. The server then performs semantic analysis to identify entities corresponding to candidates, political parties, geographic regions, and issues of public concern, and to identify semantic roles such as actor, action, object, and target. The server uses a combination of rule-based patterns and statistical models to detect candidate assertion information, such as sentences that contain policy proposals, pledges, or commitments. The server extracts policy information for each candidate by applying domain-specific rules and classifiers to the semantically analyzed text. For example, the server uses a classifier that takes as input features such as n-gram representations of tokens, part-of-speech tags, dependency relations, and named-entity labels, and outputs one or more issue categories such as environment, taxation, education, healthcare, or security. In one embodiment, the classifier is implemented as a neural network model, such as a feedforward network or a transformer-based text classifier, trained on labeled election policy data. The server uses the classifier output to assign classification information to text segments that contain candidate assertions. The server converts the extracted policy information into structured data. The server represents each policy as a record containing fields such as a candidate identifier, a candidate name, an issue category identifier, a policy text string, a policy summary string, and metadata including a source document identifier and a location pointer within the source. The server constructs data structures, for example database rows and associated index keys, that map from candidate identifiers and issue identifiers to lists of policy records. The server stores this structured data in a relational information management device, such as a relational database management system, that maintains tables for candidates, issues, policies, and cross-reference indices.

The server generates index information to accelerate retrieval of policy information. The server creates indices over fields such as candidate identifiers, issue identifiers, and keyword fields derived from the policy text and the policy summary. The server may also generate full-text indices that allow efficient keyword searching across policy text. Because the policy information is normalized and structured, the relational information management device can perform highly selective queries that access only relevant records and avoid scanning complete documents. This structure improves data access patterns, reduces I/O operations, and lowers query latency compared to systems that store only raw text.

The server provides an application programming interface that allows terminals to transmit issue designation information, candidate designation information, question information, and other parameters. When the server receives issue designation information or candidate designation information from a terminal, the server uses the relational information management device to retrieve the corresponding policy information based on the indices. The server formats the retrieved policy information into a list-comparable format, for example by constructing tabular or aligned structures where rows correspond to issues and columns correspond to candidates, or vice versa. This formatting is performed server-side so that the terminal receives already aligned policy data and does not need to perform complex restructuring. As a result, the system reduces redundant processing on multiple client devices and decreases total computational overhead in distributed deployments.

The server uses a generative AI model as a generative information processing model. In one embodiment, the generative AI model is implemented as a transformer-based neural network trained on large corpora of text. The model includes multiple layers of self-attention and feedforward sublayers, and parameters including learned weight matrices and bias vectors. The model receives as input a sequence of tokenized text representing a prompt sentence and produces as output a sequence of tokens representing a generated response. The model is trained using supervised or semi-supervised learning with an objective function such as cross-entropy loss over predicted next tokens, and the model parameters are updated using gradient-based optimization methods such as stochastic gradient descent with adaptive learning rate adjustments. The server may fine-tune the generative AI model on domain-specific corpora that include election-related texts, policy documents, and prior question-and-answer pairs to improve domain accuracy.

The server automatically generates prompt sentences for the generative AI model on the basis of structured data and question information acquired from a user. The server does not simply pass raw document text to the generative AI model; instead, the server selects relevant policy records using the index information, extracts key fields such as issue category, candidate names, and policy summaries, and programmatically constructs prompt sentences that embed this structured information in a controlled format. For example, the server generates a prompt sentence of the form:
“Compare the environment policies of Candidate A and Candidate B based on the following structured data. For each candidate, identify key measures, targets, and expected effects, and explain the main differences in simple terms suitable for a general voter.”

The server then appends a representation of the selected policy data, such as a plain-text listing of issue labels and policy summaries. Because the prompt sentence is constructed from pre-filtered, structured data, the generative AI model is provided with only the relevant context, which improves computational efficiency and reduces the risk of the model processing irrelevant or noisy text.

The server may also generate prompt sentences for extraction and summarization tasks. For example, when the server first processes new election bulletins, the server can generate a prompt sentence such as:
“From the following election bulletin text, extract all information related to environment policy and organize it by candidate, including key measures, targets, and timelines. Output in a structured, readable form.”

In this case, the server feeds the raw or partially processed text into the generative AI model together with the prompt sentence and uses the output to refine or validate the structured data. The server might parse the model's output and compare it against the results of its deterministic natural language processing pipeline. By combining rule-based extraction and generative extraction, the server can increase recall and precision of policy information.

The server associates response information produced by the generative AI model with display information that defines visual layouts and grouping on the terminal. For example, when a user requests a comparative explanation for two candidates on a particular issue, the server generates a prompt sentence, obtains a generated response, and bundles the response with a representation of the list-comparable policy data that was used to construct the prompt. The server then transmits this bundle to the terminal, which displays the list-comparable table alongside the natural-language explanation.

The server improves computer technology in several ways. First, by converting unstructured election documents into normalized structured data with relational indices, the server reduces computational complexity of retrieval operations. Instead of performing full-text scanning for each query, the server uses index lookup on candidate identifiers and issue identifiers to locate policy records. This approach decreases the number of disk reads and CPU cycles required to satisfy a typical query, resulting in lower latency and better scalability across large datasets.

Second, by generating prompt sentences from structured data rather than passing full documents to the generative AI model, the server reduces the token count processed by the model. Because transformer-based generative models typically have computational cost proportional to the square of the input sequence length, the reduction in token count yields a non-linear improvement in processing time and resource utilization. This arrangement also allows the server to enforce a domain-specific structure in prompts, which leads to more consistent and accurate responses and reduces the need for manual post-processing. Third, the server performs sentiment analysis and behavior analysis on question information and operation history information from the terminal. The server can implement sentiment analysis using a classifier model, such as a recurrent neural network or a transformer-based text classifier, trained to output scores representing user frustration, confusion, or confidence. The server adjusts the expression style and detail level of prompt sentences based on these scores. For example, if the sentiment analysis indicates confusion or low comprehension, the server adds instructions to the prompt sentence such as “Explain using short sentences and avoid technical terms.” If the sentiment analysis indicates high interest and high comprehension, the server may include instructions such as “Provide a detailed, technical comparison, including quantitative targets where available.” By controlling the prompts in this way, the server adapts the complexity of the generative AI model's output to the user's needs, reducing the likelihood of overlong or overly technical responses. This adaptation improves effective use of network bandwidth and processing resources by preventing unnecessary generation of unused detailed content.

Fourth, the server uses a multi-module architecture in which distinct components handle image recognition, text normalization, natural language processing, structured data generation, database indexing, prompt sentence construction, and generative model invocation. Data flows between these modules through defined interfaces and controlled formats, reducing duplication and ensuring that each module operates on data that has been pre-processed to the appropriate level of abstraction. This modular design enhances maintainability and allows substitution of algorithms or models without changing the overall data structures. For example, the server can replace a rule-based classifier for issue assignment with a neural network classifier while preserving the same structured data schema and index keys.

Fifth, the server uses rule-based and non-conventional procedures for combining deterministic natural language processing and generative model outputs. Instead of relying solely on a generative model to parse and understand election bulletins, the server first performs deterministic syntactic and semantic analysis to identify candidate boundaries, issue categories, and basic policy structure. The server then uses the generative AI model to refine, summarize, or compare this information. By enforcing this hybrid pipeline, the server mitigates hallucination risks and increases the reliability of the final structured data. The rules that govern how structured data is inserted into prompts, how many policies per candidate are included, and how issue labels are presented are specifically designed to optimize generative performance and are not merely human reading rules. As an example, the server may truncate each candidate's policy text to a fixed number of tokens, preserving key phrases that match domain-specific dictionaries, thereby focusing the model's attention on technically relevant segments.

The terminal operates as a client-side interface and offloads minimal processing from the server. The terminal executes a client application that runs on a mobile or desktop platform. The terminal sends issue designation information and candidate designation information to the server, and it displays list-comparable policy data and generated explanations received from the server. Because the heavy natural language processing and generative tasks are performed on the server, the terminal can be implemented as a resource-constrained device while still providing sophisticated comparative analysis capabilities. The reduction of on-device processing and the receipt of pre-structured data reduce power consumption and improve responsiveness on the terminal.

The user interacts with the terminal to specify issues of interest, select candidates, and ask questions in natural language. The user may, for example, enter the query “How do Candidate A and Candidate B differ in their environment policy?” into an input field of the terminal. The terminal transmits this question information together with candidate designation information to the server. The server then retrieves the relevant structured data, constructs a prompt sentence such as:
“Compare the environment policies of Candidate A and Candidate B based on the following structured data. For each candidate, list key measures, targets, and expected outcomes, and then explain the main differences in simple terms that a general voter can understand.”

The server appends the structured policy records, invokes the generative AI model, and returns the generated comparative explanation. The terminal displays a table listing each candidate's environment policy items along with the generated explanation below the table.

In another example, the user may ask for clarification of a single candidate's tax policy by entering the question “Explain in simple terms how Candidate A's tax policy would affect middle-income households.” The server generates a prompt sentence such as:
“Explain in simple terms how the following tax policy of Candidate A would affect middle-income households. Focus on practical effects such as changes in take-home pay, cost of living, and available public services.”

The server then appends the relevant policy text and summary and obtains a response from the generative AI model. Because the prompt is tied directly to structured data, the model operates within a controlled context, improving accuracy and reducing unnecessary computation.

Alternative embodiments may modify individual components while preserving the core technical concepts. For example, the server may use a different type of relational information management device, such as a distributed relational database, or may augment relational storage with a key-value store for caching frequently accessed structured policy data. The natural language processing pipeline may be implemented with different libraries or frameworks, or may utilize a joint model that performs part-of-speech tagging, syntactic analysis, and semantic role labeling in a single neural network architecture. The generative AI model may be hosted by a third-party service or deployed on-premises; in either case, the prompt sentence generation and structured data selection are performed by the server as described, so that the system maintains its technical advantages in efficiency and accuracy. Through these embodiments, the server, the terminal, and the user cooperate in a manner that transforms raw election-related documents into structured, indexed, and comparison-ready data, and that uses a generative AI model under the control of specifically designed prompt sentences. This arrangement improves computer technology by enhancing data management, increasing retrieval and generation efficiency, reducing computational and communication overhead, and delivering more accurate and user-appropriate comparative policy explanations than conventional systems that rely on generic document search or unstructured generative processing.

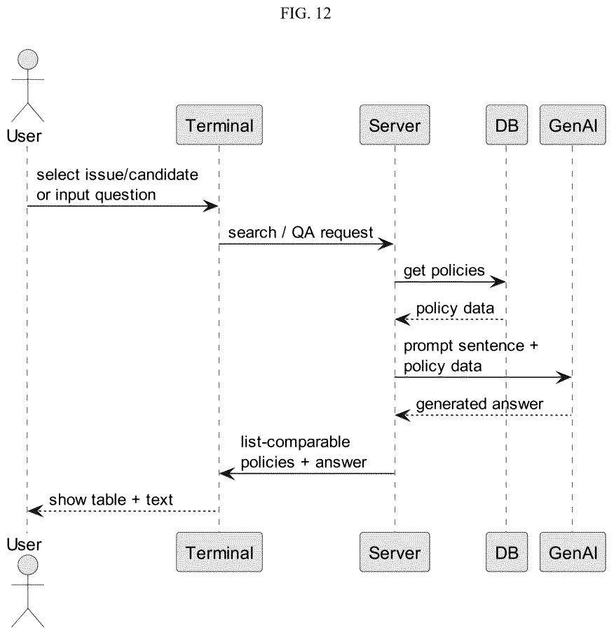

The following describes the processing flow using FIG. 12.

### Step 1:

Server receives election-related document information as input data from an external source, such as a file repository or an administrative system, in the form of image files or mixed image/text files.

Server stores the received files in a storage device and registers metadata such as file name, document type, and acquisition time.

Server outputs stored document files and associated metadata for subsequent image and text processing.

### Step 2:

Server takes the stored document files as input and performs image recognition processing to detect page regions and text blocks.

Server applies image preprocessing operations such as grayscale conversion, binarization, and noise reduction, then executes layout analysis to segment the page into text regions and non-text regions.

Server outputs cropped text-region images together with region coordinates and document identifiers.

### Step 3:

Server inputs the cropped text-region images and performs character recognition processing to convert the images into electronic character information.

Server executes character segmentation, feature extraction, and classification using an optical character recognition engine, then normalizes the recognized characters into a unified encoding such as UTF-8.

Server outputs electronic text strings associated with region coordinates and source document identifiers.

### Step 4:

Server receives the electronic text strings as input and applies natural language processing to tokenize, tag, and analyze sentence structure.

Server performs tokenization to split text into tokens, applies part-of-speech tagging, and executes syntactic parsing to build dependency trees or parse trees for each sentence.

Server outputs syntactically annotated text that includes tokens, part-of-speech tags, and syntactic relations.

### Step 5:

Server takes the syntactically annotated text as input and performs semantic analysis to detect candidate assertion information and policy-related segments.

Server applies named-entity recognition to identify candidate names, organizations, regions, and issue-related terms, and uses rule-based patterns and classifier scores to select sentences that express policies, pledges, or commitments.

Server outputs extracted candidate assertion segments linked with candidate identifiers, issue-related terms, and source positions.

### Step 6:

Server uses the candidate assertion segments as input and assigns one or more issue categories to each segment.

Server computes feature vectors from each segment, including n-gram features, part-of-speech patterns, dependency paths, and entity labels, and feeds the feature vectors to a trained classifier such as a neural network or transformer-based text classifier.

Server outputs classification information that associates each segment with issue categories such as environment, taxation, education, or healthcare.

### Step 7:

Server inputs the classified candidate assertion segments and converts them into structured policy records.

Server constructs records that include fields such as candidate identifier, candidate name, issue category identifier, full policy text, and metadata including source document ID and location.

Server outputs structured policy data represented as records or objects ready for database insertion.

### Step 8:

Server optionally receives long policy texts as input and generates policy summaries using a generative AI model.

Server constructs a prompt sentence such as “Summarize the following policy statement in one or two sentences for general voters:” followed by the policy text, then sends this prompt sentence to the generative AI model via an interface.

Server receives the generated summary text as output and appends it to the corresponding policy record as a summary field.

### Step 9:

Server takes the structured policy data, including optional summaries, as input and stores the data in a relational information management device.

Server generates and executes insert statements to populate tables for candidates, issues, and policies, and creates index structures on fields such as candidate identifiers, issue identifiers, and keyword columns derived from policy text.

Server outputs stored database records and index entries that support efficient query and retrieval.

### Step 10:

Terminal receives initial configuration or menu information from the server as input and displays an interface for election information search.

Terminal renders selectable issue categories, a candidate search field, and a free-text question input area, and waits for user interaction.

Terminal outputs user input events, such as selected issues and candidate filters, as request parameters to the server.

### Step 11:

User inputs issue designation information and/or candidate designation information into the terminal.

User selects one or more issue categories from a list, types keywords such as “environment policy”, or chooses specific candidates from a candidate list.

User causes the terminal to output a search request that includes the issue designation information, candidate designation information, and optional keyword information.

### Step 12:

Terminal receives the user's search parameters as input and constructs a request message for the server.

Terminal encodes the issue designation information, candidate designation information, and keyword information into request parameters and sends the request over a network connection to the server.

Terminal outputs an HTTP or similar protocol request that reaches the server's search interface.

### Step 13:

Server receives the search request from the terminal as input and validates the request parameters.

Server checks that issue identifiers and candidate identifiers are in valid formats and applies default conditions if some parameters are missing, such as selecting all candidates for a given issue.

Server outputs validated query parameters for use in database retrieval.

### Step 14:

Server uses the validated query parameters as input to retrieve policy information from the relational information management device.

Server constructs database queries that filter policy records by candidate identifiers, issue identifiers, and keyword matches, and executes the queries using existing indices to minimize full-table scans.

Server outputs a result set of policy records that satisfy the specified conditions.

### Step 15:

Server receives the result set of policy records as input and formats the records into a list-comparable format.

Server groups the policy records by issue and by candidate, orders them according to predefined rules, and constructs structured output such as tables where each row corresponds to an issue item and each column corresponds to a candidate.

Server outputs a formatted data structure representing the list-comparable policy information ready for transmission to the terminal.

### Step 16:

Server optionally uses the formatted policy data and user question information as input to generate a prompt sentence for the generative AI model.

Server selects only the subset of policy records relevant to the user's chosen issues and candidates, inserts their summaries and labels into a template, and constructs a prompt sentence such as “Compare the environment policies of Candidate A and Candidate B based on the following structured data. For each candidate, list key measures and explain the main differences in simple terms.”

Server outputs the constructed prompt sentence and the embedded policy content as input to the generative AI model.

### Step 17:

Server sends the prompt sentence and associated content as input to the generative AI model and receives response information as output.

Server encodes the prompt into tokens, passes the token sequence to the generative model, and obtains a sequence of generated tokens that represents an explanation, summary, or comparison of the policy data.

Server decodes the token sequence into text and outputs a natural-language response associated with the relevant policy records.

### Step 18:

Server takes the list-comparable policy data and the generated response information as input and prepares a response message for the terminal.

Server associates the generated explanation with the corresponding policy table, adds display attributes such as section titles and emphasis flags, and packs the combined data into a structured response format.

Server outputs a response message that includes both the formatted policy list and the generative AI model's explanation.

### Step 19:

Terminal receives the response message from the server as input and updates the user interface accordingly.

Terminal parses the list-comparable policy data to render tables or aligned lists for each candidate and issue, and displays the generated explanation below or beside the table as narrative text.

Terminal outputs a visual presentation that allows the user to compare candidate policies and read the AI-generated explanation.

### Step 20:

User observes the displayed policy comparison and explanation and may input follow-up question information into the terminal.

User types a natural-language question such as “Explain in simple terms how Candidate A's tax policy affects middle-income households,” possibly while viewing specific policy entries. User causes the terminal to output the follow-up question, along with context such as currently selected candidates and issues, to the server for further processing.

### Step 21:

Terminal accepts the follow-up question and current context as input and constructs a new request to the server.

Terminal packages the question information, active issue designation information, and active candidate designation information into a structured request and transmits the request over the network.

Terminal outputs the request as a message that prompts the server to generate an additional explanation.

### Step 22:

Server receives the follow-up request as input and retrieves detailed structured data for the relevant candidate and issue from the relational information management device.

Server uses indices to efficiently locate the exact policy records referenced by the user's context, such as a particular candidate's tax policy entries.

Server outputs a focused subset of structured policy records that serves as the knowledge basis for the next generative explanation.

### Step 23:

Server uses the focused structured policy records and the follow-up question as input to construct a new prompt sentence for the generative AI model.

Server forms a prompt such as “Explain in simple terms how the following tax policy of Candidate A would affect middle-income households, focusing on changes in take-home pay and cost of living,” then appends the relevant policy text and summaries.

Server outputs the constructed prompt sentence with embedded policy content as input to the generative AI model.

### Step 24:

Server transmits the constructed prompt to the generative AI model and obtains the generated answer as output.

Server further checks the generated answer for length constraints or formatting requirements and may truncate or segment the answer to fit display limitations.

Server outputs a refined answer text that is aligned with the user's question and the selected policy records.

### Step 25:

Server combines the refined answer text with updated display information and sends a response to the terminal.

Server indicates which policy entries correspond to the explanation, for example by including identifiers or flags that the terminal can use to highlight those entries.

Server outputs a final response message that the terminal can use to present a coherent, context-aware explanation.

### Step 26:

Terminal receives the final response message as input and updates the display to show the new explanation in association with the relevant policy entries.

Terminal highlights the entries referenced in the explanation, scrolls or focuses the view if necessary, and renders the answer text in a readable view, such as a chat-style panel or an explanation section.

Terminal outputs an updated user interface that integrates structured policy data and generative explanations for continued user interaction.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”

Conventional information processing systems that handle textual descriptions of policies or promises suffer from several technical limitations when implemented on general-purpose computer hardware. First, such systems typically rely on simple keyword matching or rule-based classification, which does not scale well as the volume and diversity of text data increase. As the number of input documents and categories grows, the processor is forced to perform repetitive pattern searches and table lookups that cause increased latency, excessive memory usage, and degraded throughput. This results in inefficient utilization of processing resources and limits the responsiveness of the system to user queries.

Second, conventional systems treat text ingestion, classification, and response generation as separate, loosely coupled modules. Optical character recognition, natural language preprocessing, category assignment, and answer generation are often implemented as independent components with rigid interfaces. As a result, optimizations at one stage, such as improved tokenization or feature extraction, cannot be propagated effectively to later stages, such as answer generation or comparison. This fragmented pipeline prevents the processor from dynamically tailoring intermediate representations to the needs of generative models, thereby limiting the quality and consistency of responses and making it difficult to maintain low-latency, high-accuracy behavior on commodity hardware.

Third, known systems do not systematically exploit generative artificial intelligence models as an integral control element in the overall data path. Generative models, if used at all, are often invoked as a final-stage text generator without being tightly integrated with upstream preprocessing and classification logic. This leads to redundant computations, because the generative model must internally re-interpret the raw text without reusing structured analysis that has already been computed by the processor. Consequently, the processor performs overlapping linguistic analyses multiple times, which wastes processing cycles and memory bandwidth and reduces the scalability of the system with respect to the number of concurrent users.

Fourth, conventional question-answering interfaces over policy or promise data generally require users to formulate complex queries or navigate manually through large collections of documents. The processor tends to execute multiple ad hoc search and filtering operations for each query, which increases computational overhead and causes inconsistent response times. Moreover, the system often returns unstructured or poorly organized information, making it difficult for the processor to support efficient comparison or aggregation operations, and forcing users to perform manual interpretation outside the system.

Fifth, typical systems do not adapt the interaction with generative models based on sentiment or contextual characteristics of the input. Prompt sentences sent to generative models are often static templates that do not account for the tone, sensitivity, or complexity of the user's inquiry or the underlying text. This failure to dynamically adjust prompts prevents the processor from optimizing generative model behavior for different use cases, which can lead to suboptimal responses and unnecessary additional queries. It further results in inefficient use of computational resources, because the model may generate overly long, overly short, or inappropriate responses that need to be corrected in follow-up interactions.

Accordingly, there is a need for a technical solution that re-architects the way a processor on a server acquires text data about policies or promises, preprocesses and classifies such data, constructs prompt sentences, and interacts with a generative artificial intelligence model. The technical problem is how to design and configure the processor so that it can unify optical character recognition, natural language preprocessing, structured classification, and generative response generation into a coordinated processing pipeline. Such a pipeline should reduce redundant computations, optimize data representations for downstream generative processing, and enable the processor to generate listable and comparable representations of multiple texts and to answer user inquiries efficiently. Furthermore, there is a need to improve the way the processor constructs and adjusts prompt sentences, including based on sentiment analysis, so that the generative model can produce high-quality, context-appropriate responses with reduced computational overhead and improved utilization of processing and memory resources.

The specific processing by the specific processing unit 290 of the data processing device 12 in Example 2 is realized by the following means.

The present invention provides a server comprising a processor configured to acquire character information from an information medium that records information regarding policies or promises, convert the character information into text data by using an optical character recognition technique or a text input technique, perform preprocessing on the text data including morphological analysis, token segmentation, removal of unnecessary terms, and stemming, associate the preprocessed text data with identifiers and classification information based on a natural language processing technique so as to organize the policies or promises into a listable and comparable form, generate a prompt sentence including a classification instruction, an explanation instruction, or a comparison instruction based on the preprocessed text data and the identifiers or the classification information, input the prompt sentence as a part of input data to a generative information processing model, convert a classification result, explanation information, or comparison result obtained from the generative information processing model into response information in a format understandable to a user, output the response information to a display device, store the response information based on the identifiers or the classification information, and provide the stored response information as an intelligent service that presents a plurality of policies or promises in the listable and comparable form, and further configured to generate, based on inquiry information acquired from the user and the information organized into the listable and comparable form, a prompt sentence including an extraction result of a policy or promise corresponding to the inquiry information and input the prompt sentence to the generative information processing model so as to generate response information to a question from the user, and execute sentiment analysis on the text data and the inquiry information, and adjust a tone, a degree of detail, or an output format of the prompt sentence to the generative information processing model based on a result of the sentiment analysis so as to control contents of the response information generated by the generative information processing model. This enables an integrated and technically improved processing pipeline on the server that reduces redundant linguistic computations, optimizes data representations for interaction with the generative information processing model, increases efficiency and scalability of classification and comparison of policy or promise texts, and dynamically adapts prompt sentences and generated responses to user context, thereby improving the overall performance and resource utilization of the computer system.

The term “information medium” refers to a physical or electronic storage entity, such as a document, an image, or a digital file, in which information regarding policies or promises is recorded in a human-readable or machine-readable form.

The term “policy” refers to a planned course of action, objective, or guideline publicly declared by an individual, organization, or group, which is expressed as textual information.

The term “promise” refers to a declared commitment or pledge by an individual, organization, or group to perform or refrain from performing certain actions, which is expressed as textual information.

The term “information processing apparatus” refers to a computing apparatus including at least one processor, memory, and an interface, configured to execute programs for processing, storing, and transmitting digital data.

The term “processor” refers to a hardware computing unit, such as a central processing unit or an execution core, configured to execute machine-readable instructions to perform operations on data.

The term “acquisition device” refers to a hardware or software component, such as an image capture device, a scanner, or an input interface, configured to acquire character information from an information medium and provide the information to the processor.

The term “character information” refers to symbolic information representing characters, letters, numerals, or symbols that can be converted into text data by a recognition or input process.

The term “text data” refers to a sequence of characters or tokens encoded in a digital format, representing the content of policies or promises in a machine-processable form. The term “optical character recognition technique” refers to a computational procedure in which an image containing printed or handwritten characters is analyzed to detect and convert those characters into corresponding digital text data.

The term “text input technique” refers to a method by which a user or an external system directly inputs textual content into the information processing apparatus through an interface such as a keyboard, a touch panel, a voice recognition interface, or an application programming interface.

The term “preprocessing” refers to a series of computational operations applied to raw text data to normalize and structure the data, including at least one of morphological analysis, token segmentation, removal of unnecessary terms, and stemming.

The term “morphological analysis” refers to a natural language processing operation that decomposes text data into morphologically meaningful units, such as words or word stems, and may assign grammatical attributes to those units.

The term “token segmentation” refers to a process of dividing text data into discrete units, called tokens, such as words, subwords, or punctuation symbols, for subsequent processing by the processor or a model.

The term “removal of unnecessary terms” refers to an operation that identifies and removes tokens that are determined to contribute little to semantic analysis, such as function words, stop words, or noise characters, based on predetermined criteria.

The term “stemming” refers to a linguistic normalization process that reduces related word forms to a common base form or root to consolidate semantic variations of the same lexical item.

The term “natural language processing technique” refers to a computational technique for analyzing, interpreting, or transforming human language text using algorithms, models, or rules, including but not limited to parsing, semantic analysis, and classification.

The term “identifier” refers to a symbolic label or tag assigned to text data to denote a specific feature, topic, or attribute that can be used to categorize or index the text.

The term “classification information” refers to structured data indicating one or more categories, groups, or classes assigned to text data based on its content characteristics.

The term “listable and comparable form” refers to a structured representation of multiple items of text data such that the items can be displayed, sorted, filtered, or contrasted side by side according to identifiers or classification information.

The term “prompt sentence” refers to a textual instruction or query, optionally including context or constraints, provided as part of input data to a generative information processing model to induce the model to perform a specified operation.

The term “classification instruction” refers to a part of a prompt sentence that explicitly or implicitly requests the generative information processing model to determine one or more categories or labels for given text data.

The term “explanation instruction” refers to a part of a prompt sentence that requests the generative information processing model to generate natural-language reasoning or justification for a classification, selection, or comparison.

The term “comparison instruction” refers to a part of a prompt sentence that requests the generative information processing model to identify similarities, differences, advantages, or disadvantages between two or more items of text data.

The term “input data” refers to a structured data set provided to the generative information processing model, including at least one prompt sentence and optionally preprocessed text data, identifiers, or classification information.

The term “generative information processing model” refers to a trained computational model, such as a generative artificial intelligence model, configured to generate text or other output data in response to input data including a prompt sentence.

The term “classification result” refers to output data from the generative information processing model or the processor that indicates one or more categories, labels, or identifiers assigned to given text data.

The term “explanation information” refers to output data generated by the generative information processing model or the processor that provides textual reasoning, description, or justification for a classification, extraction, or comparison.

The term “comparison result” refers to output data indicating relationships, similarities, differences, or prioritized distinctions among a plurality of policies or promises based on their content.

The term “response information” refers to structured or unstructured output data generated by the processor based on results from the generative information processing model, which is formatted for presentation to a user.

The term “display device” refers to an output device, such as a monitor, a terminal display, or a graphical user interface component, configured to visually present response information to a user.

The term “intelligent service” refers to a function or application executed by the processor that utilizes the generative information processing model and stored response information to provide context-aware, dynamically generated information to a user.

The term “inquiry information” refers to text data or structured data representing a question, request, or query received from a user and intended to obtain specific information or analysis from the system.

The term “sentiment analysis” refers to a computational process that determines an affective or attitudinal property, such as positivity, negativity, or emotional tone, of text data including policies, promises, or inquiry information.

The term “tone” refers to a stylistic or emotional characteristic of generated text, such as formality level, politeness level, or emotional intensity, which can be adjusted for response information.

The term “degree of detail” refers to a level of granularity or length of information provided in response information, such as whether the response is summarized, concise, or elaborated.

The term “output format” refers to a structural style of presenting response information, such as narrative text, bullet points, tabular form, or labeled sections, which can be controlled by the processor through prompt sentences.

In one embodiment, a server implements the claimed system as a network-accessible information processing apparatus configured to acquire, analyze, classify, and present textual information regarding policies or promises. The server includes at least one processor, a main memory, a non-volatile storage device, a network interface, and an interface to one or more acquisition devices. The server executes system software such as an operating system (for example, a general-purpose server operating system), an application server framework (for example, a web application framework), and a machine learning framework (for example, a tensor-based numerical computation library or a general-purpose deep learning library). The server stores, in the non-volatile storage device, an executable program that realizes the functions described below when loaded into the main memory and executed by the processor. The terminal is a user-operated computing device, such as a smartphone, tablet, or personal computer, including a processor, memory, a display device, and an input interface. The terminal executes a client application, such as a web browser or a dedicated application, that communicates with the server via a communication network. The user operates the terminal to supply information media, view response information, and issue inquiries.

The server cooperates with an acquisition device to obtain character information from an information medium. The acquisition device can include an image sensor such as a scanner or camera that captures a document containing policies or promises, and a communication module that transmits the captured image to the server. Alternatively, the acquisition device can include a user interface component on the terminal by which the user directly inputs text; in such a case, the terminal transmits the text data to the server through a network connection. By using these acquisition devices, the server obtains character information and corresponding text data in a uniform internal representation, allowing efficient subsequent processing.

The server executes a text conversion module that transforms received character information into text data. When the acquisition device provides an image, the server performs optical character recognition using an algorithm that segments the image into character regions, extracts features such as stroke shapes and contour patterns, and maps these features to character codes. The server may use an OCR engine that applies a convolutional neural network to recognize character patterns in a pixel matrix. When the acquisition device provides already-digitized text (for example, via a text input form on the terminal), the server applies a text input technique to normalize encoding, correct character sets, and detect basic structural units such as paragraphs and sentences. The server thereby generates normalized text data representing the content of policies or promises.

The server then executes a preprocessing module that performs a sequence of natural language processing operations on the text data. In one embodiment, the server uses a tokenizer implementing a subword segmentation algorithm to convert raw text into tokens. The server applies morphological analysis to assign part-of-speech tags and lemmas, using a trained statistical tagger such as a conditional random field-based tagger or a neural sequence tagger. The server removes unnecessary terms, such as language-dependent stop words and boilerplate phrases, using a configurable stop list and frequency-based filtering. The server performs stemming or lemmatization so that different inflected or derived forms of a word are mapped to a common base representation. This preprocessing step converts unstructured text into a compact sequence of token identifiers and associated linguistic features stored in a structured data format, such as a sequence of token records containing token IDs, part-of-speech tags, lemma IDs, and position indexes.

The server associates the preprocessed text data with identifiers and classification information. The server maintains a classification schema consisting of multiple categories, such as high-level topics (for example, energy, environment, economy, education), and more granular identifiers (for example, taxation, healthcare, infrastructure). The server represents this schema using data structures such as a label index and a hierarchical category tree. The server applies a classification algorithm that maps each token sequence to one or more category labels. In one embodiment, the server uses a neural classifier implemented as a transformer encoder network with multiple self-attention layers. The server converts the token sequence into a sequence of embedding vectors using an embedding matrix; then the transformer encoder computes contextualized embeddings by multi-head attention and feed-forward transformations. The server aggregates the sequence-level representation (for example, by taking the embedding at a special classification token or by pooling across tokens) and applies a fully connected output layer with a softmax or sigmoid activation to produce a probability distribution over the category labels. The server then selects labels with probability values exceeding a configurable threshold and stores them as identifiers and classification information linked to the corresponding text data.

The server generates a listable and comparable form of multiple policies or promises by storing, in a structured data store such as a relational database or a key-value store, records containing text identifiers, preprocessed token representations, and associated classification information. The server maintains indexes on category labels and identifiers so that category-based retrieval operations can be performed with low latency. Because the server uses normalized token IDs and compressed embeddings rather than raw text for indexing and classification, the server reduces memory footprint and improves cache utilization, thereby enhancing processing speed for high-volume workloads.

The server constructs a prompt sentence for a generative AI model based on the preprocessed text data and associated identifiers. The server executes a prompt construction module that applies rule-based templates parameterized by category labels, user query types, and target output formats. For example, when the server is configured to classify a newly input policy, the server may generate a prompt sentence such as:
“Classify the following policy text into appropriate categories (for example, energy, environment, economy, education) and output the categories as a list: We promise to promote renewable energy.”

When the server is configured to request an explanation from the generative AI model, the server may generate a prompt sentence such as:
“Explain in one concise paragraph why the following text belongs to the categories energy and environment: We promise to promote renewable energy.”

When the server is configured to perform comparison between policies, the server may generate a prompt sentence such as:
“Compare the following two policy texts and describe the main differences in their focus on environmental impact: Text A: We promise to promote renewable energy. Text B: We will maintain the current energy mix for the next decade.”

The server can also construct prompts for summarization or aggregation, such as:
“From the following list of policy texts, extract and summarize only those related to energy in no more than five bullet points: [list of texts].”

The server encodes each prompt sentence and the associated context (such as tokenized text and label information) into an input data structure suitable for a generative AI model. The server uses a tokenizer compatible with a transformer-based generative model to convert the prompt sentence into token IDs, and constructs positional encodings and attention masks as required by the model architecture.

The server executes a generative information processing model implemented on a deep learning framework. In one embodiment, the server uses a transformer-based sequence-to-sequence network with an encoder-decoder architecture. The encoder receives the tokenized prompt sentence and text context and computes contextual hidden states via multiple layers of multi-head attention and feed-forward sublayers. The decoder generates output tokens step-by-step, attending to both previous decoded tokens and encoder states. The server configures hyperparameters such as the number of layers, the number of attention heads, embedding dimensionality, and feed-forward width to achieve a balance between accuracy and computational load. The server uses efficient numerical libraries and, in some embodiments, a graphics processing unit or specialized accelerator to perform parallel matrix multiplications and attention operations.

The server trains or fine-tunes the generative AI model using supervised or reinforcement learning techniques prior to deployment. During training, the server stores training data containing example prompt sentences, input texts, and desired outputs, such as correct classifications, explanations, and comparisons. The server computes an objective function, such as cross-entropy loss for sequence prediction or a combined loss that includes classification accuracy and explanation quality metrics. The server performs backpropagation to compute gradients of the loss with respect to model weights and updates the weights using an optimization algorithm such as stochastic gradient descent with momentum or an adaptive method. The server may apply data augmentation techniques such as paraphrasing, noise injection, or category balancing to improve robustness. By training the model to respond accurately to the specific types of prompt sentences used in the system, the server improves both response accuracy and computational efficiency because the model learns compact internal representations tailored to the policy and promise domain.

The server executes a sentiment analysis module that analyzes both the text data of policies or promises and the inquiry information from the user. In one embodiment, the server implements sentiment analysis as a separate neural classifier or as a multi-task head sharing the encoder of the generative model. The server computes features such as polarity scores and emotional tone labels and stores them as sentiment attributes in association with each text or inquiry. When constructing a prompt sentence, the server uses these sentiment attributes to adjust parameters such as tone, degree of detail, and output format. For example, when the user submits a highly negative or sensitive inquiry, the server may insert prompt phrases directing the model to respond in a more neutral and detailed manner, such as:
“Answer in a calm, neutral tone and provide detailed, step-by-step reasoning.” By explicitly encoding such instructions in the prompt sentence, the server steers the generative model's decoding path, resulting in responses that are better matched to user context while avoiding unnecessary length or inappropriate style. This adaptive prompt construction reduces the need for repeated follow-up queries, thereby reducing overall processing load and network traffic.

The server converts classification results, explanation information, or comparison results obtained from the generative AI model into response information. The server decodes the sequence of output token IDs from the model into characters and words, applies postprocessing such as punctuation normalization and de-tokenization, and structures the result into fields such as categories, explanations, comparisons, and summaries. The server formats the response information in a representation suitable for the terminal, such as a structured response containing categorized lists, highlighted key phrases, and textual explanations. The server may also compress and cache frequently requested response information to reduce repeated computation.

The terminal receives response information from the server via a communication protocol and displays it on the display device. The terminal arranges multiple policies or promises side by side in a listable and comparable layout, for example by placing categories in columns and textual explanations in rows. The user views this structured presentation and can quickly compare content across different policies or promises without manually scanning entire documents. The terminal may allow the user to filter or sort items by category, sentiment, or other attributes received from the server.

The user issues inquiry information by operating the terminal. The user can input free-form questions, such as:
“What are the main energy-related pledges?”
or more specific requests, such as:
“Summarize all environment-related promises in three bullet points.”

The terminal transmits this inquiry information to the server. The server retrieves policies or promises matching the inquiry using the stored classification information and constructs an appropriate prompt sentence that includes both the selected texts and an explicit instruction. For example, the server may create a prompt such as:
“From the following list of policy texts, extract only those related to environment and summarize them in no more than three bullet points: [selected texts].”

The server inputs this prompt sentence to the generative AI model and returns the generated summary as response information to the terminal. This architecture allows the server to reuse precomputed classification and sentiment attributes to restrict the search space and reduce the amount of text that needs to be processed by the generative model, which lowers computation time and improves responsiveness.

The server achieves technical improvements beyond mere automation of human reading. Because the server uses preprocessed token representations, hierarchical label structures, and cached embeddings, the server reduces redundant language analysis operations that would otherwise be repeated by the generative model internally. By providing the generative model with prompt sentences that already encode context, categories, and sentiment, the server allows the model to perform fewer inference steps to arrive at a suitable answer. This reduces the number of decoding iterations, lowers energy consumption on the processing hardware, and reduces memory bandwidth usage. Additionally, the sentiment-based prompt adjustment dynamically controls output length and style, preventing excessively long or off-topic outputs that would increase processing time and network load.

The server further improves accuracy and stability of classification and explanation by separating deterministic preprocessing and classification from generative explanation. The server uses a discriminative classifier with calibrated probability outputs to determine categories, and then uses the generative model primarily to produce natural-language justifications and comparisons. This division of labor allows the server to exploit the strengths of each algorithm: the classifier provides consistent and efficient label assignments, while the generative model focuses on human-readable articulation. As a result, the server produces more accurate and interpretable responses than systems that rely solely on unconstrained generative behavior.

The server applies non-conventional processing flows that differ from standard manual or rule-based approaches. Rather than performing direct keyword search each time the user submits a query, the server first converts all text into a shared vector representation and classification space. This representation is then reused for multiple operations, including retrieval, comparison, summarization, and explanation. Because these vector representations and classifications are computed once and stored, subsequent queries operate on compact numerical structures rather than raw, unindexed text. This architecture results in lower latency for repeated operations and supports high concurrency with less hardware.

In alternative embodiments, the server can implement different architectures for the generative AI model, such as a decoder-only transformer or a recurrent neural network with attention. The server can vary hyperparameters such as layer depth, hidden dimension, and vocabulary size depending on available hardware. The server can also implement alternative sentiment analysis methods, such as lexicon-based scoring combined with neural classification, or extend the classification schema to include additional policy-related categories. The terminal can be implemented as a native mobile application, a desktop application, or a browser-based interface, as long as it can transmit user input and display response information. The acquisition device can include other sensors, such as microphones combined with speech recognition to create text data from spoken policies or promises. All such variations are within the scope of the described embodiments, as long as the server performs the essential operations of acquiring text, preprocessing it, associating it with identifiers, generating prompt sentences, interacting with a generative AI model, and producing listable and comparable response information for the user.

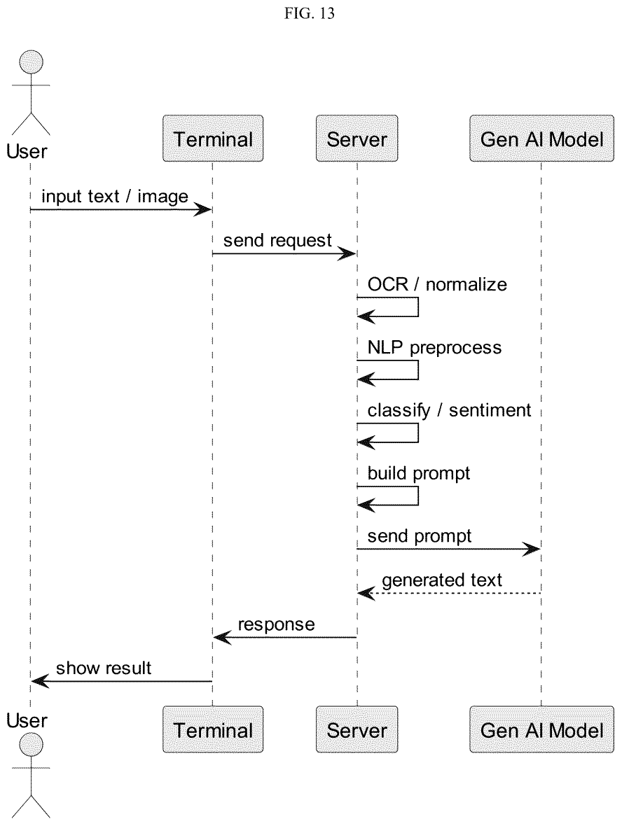

The following describes the processing flow using FIG. 13.

### Step 1:

The user operates the terminal to provide policy or promise information.

The user selects an input method on the terminal, such as uploading an image of a document, pasting text into a text field, or typing a policy statement like “We promise to promote renewable energy.”

The terminal receives, as input, either an image file containing character information or raw text entered by the user.

The terminal packages the input into a request including metadata (for example, user ID, language setting, and input type) and outputs a structured data packet ready for transmission to the server.

### Step 2:

The terminal transmits the structured data packet to the server.

The terminal uses a communication protocol, such as HTTPS over TCP/IP, to send an API request containing the input image or text to a designated endpoint on the server.

The input to this step is the structured data packet generated in Step 1.

The terminal encapsulates the input in a request message, serializes text fields into a defined encoding, and outputs a network message on the communication interface that is delivered to the server.

### Step 3:

The server receives the network message and extracts the user input.

The server, running a web application framework, parses the incoming request, authenticates it if necessary, and identifies whether the payload contains an image or raw text.

The input to this step is the network message from the terminal.

The server decodes the message, validates the format, and outputs normalized input data that includes either an image buffer (for image input) or a text string (for text input), along with associated metadata.

### Step 4:

The server converts character information into text data.

When the input includes an image, the server executes an optical character recognition engine to detect character regions, extract visual features, and map those features to character codes, thereby converting pixel data into textual content.

When the input includes already-digitized text, the server applies a text input normalization function that checks and converts encoding, unifies line breaks, and segments the content into sentences.

The input to this step is the normalized input data from Step 3.

The server processes the image or text through OCR or normalization routines, performs pattern recognition or encoding conversion, and outputs standardized text data representing the policies or promises as a continuous sequence of characters.

### Step 5:

The server performs linguistic preprocessing on the standardized text data.

The server executes a tokenizer to split the text into tokens (for example, words or subwords), applies morphological analysis to assign part-of-speech tags and lemmas, removes unnecessary terms such as stop words and boilerplate expressions, and performs stemming or lemmatization.

The input to this step is the standardized text data from Step 4.

The server applies a sequence of algorithms-token segmentation, tagging, stop-word filtering, and word normalization-to transform the raw text into a structured representation, and outputs a token sequence in which each token is associated with attributes such as token ID, lemma, part-of-speech, and position index.

### Step 6:

The server generates internal feature representations and associates initial identifiers with the token sequence.

The server maps each token ID to an embedding vector using a learned embedding matrix and may concatenate or combine additional features, such as part-of-speech encodings and positional encodings.

The input to this step is the token sequence with attributes from Step 5.

The server performs matrix lookup and numerical transformation operations to compute dense numerical vectors for each token, aggregates these vectors into a sequence tensor, and outputs a feature representation suitable for classification and further processing, along with any preliminary identifiers derived from rules (for example, detecting obvious domain-specific keywords).

### Step 7:

The server classifies the text into one or more categories based on the feature representation. The server inputs the feature representation into a discriminative classifier, such as a transformer encoder with a classification head, computes contextualized embeddings via multi-head attention and feed-forward layers, and generates category scores for labels such as energy, environment, economy, and education.

The input to this step is the feature representation from Step 6.

The server performs tensor operations (matrix multiplications, non-linear activations, and normalization), calculates probability values for each category using softmax or sigmoid functions, and outputs a set of identifiers and classification information consisting of selected category labels and their associated scores.

### Step 8:

The server stores the classified text and creates a listable and comparable record.

The server constructs a data record that links the original text, the token sequence, the feature representation (optionally compressed), the identifiers, the classification information, and any sentiment attributes (if already computed).

The input to this step is the standardized text data from Step 4 and the classification information from Step 7.

The server writes this data into a structured storage system, updates indexes on identifiers and categories, and outputs a persistent record ID and updated indexes that allow efficient retrieval and comparison of multiple policies or promises.

### Step 9:

The server executes sentiment analysis on the text and any associated user inquiry.

The server inputs the token sequence and feature representation into a sentiment classifier that computes polarity, emotional tone, or other affective attributes. If an inquiry from the user is present, the server applies the same analysis to the inquiry text.

The input to this step is the token sequence and feature representation from Step 6, and optionally the inquiry text processed by Steps 4-6.

The server performs additional classification operations, computes sentiment scores and labels, and outputs sentiment attributes linked to each piece of text and inquiry, which are stored or passed forward to influence prompt construction.

### Step 10:

The server constructs a prompt sentence for a generative AI model.

The server selects a template based on the processing objective (for example, classification explanation, comparison, or summarization) and fills the template with the standardized text, the identifiers, the classification information, and, if available, the sentiment attributes.

The input to this step is the standardized text data from Step 4, the identifiers and classification information from Step 7, and the sentiment attributes from Step 9.

The server applies rule-based or parameterized formatting logic to generate a natural-language prompt sentence, such as:
“Classify the following policy text into appropriate categories (for example, energy, environment, economy, education) and output the categories as a list: We promise to promote renewable energy.”
or
“Explain in one concise paragraph why the following text belongs to the categories energy and environment: We promise to promote renewable energy.”

The server outputs a complete prompt sentence together with any required context that will be supplied to the generative AI model.

### Step 11:

The server tokenizes and encodes the prompt sentence for input to the generative AI model. The server uses a model-specific tokenizer to convert the prompt sentence into prompt tokens, generates positional encodings and attention masks, and combines these with any text context tokens if the model requires both prompt and context in a single sequence.

The input to this step is the prompt sentence from Step 10 and, optionally, the token sequence from Step 5.

The server performs string-to-token mapping, constructs numerical arrays for token IDs, positions, and masks, and outputs an input tensor formatted according to the generative model's specification.

### Step 12:

The server performs inference with the generative AI model using the encoded prompt.

The server loads the generative AI model parameters into memory, applies the input tensor to the model, and executes multiple layers of self-attention and feed-forward computation to generate output token probabilities step-by-step or in parallel, depending on the architecture. The input to this step is the encoded prompt tensor from Step 11.

The server runs tensor operations on the processor and, when available, on an accelerator, samples or selects output tokens according to decoding strategies (for example, greedy decoding or beam search), and outputs a sequence of output token IDs representing classification results, explanation information, comparison results, or summaries as natural-language text.

### Step 13:

The server postprocesses the generative AI model output into structured response information.

The server decodes the output token IDs into characters and words, removes any technical markers or control tokens, and segments the output into logical parts such as category lists, explanation paragraphs, and comparison sections.

The input to this step is the sequence of output token IDs from Step 12.

The server performs token-to-string conversion, text cleaning, and structural parsing to generate a formatted response, and outputs structured response information containing explicit fields (for example, categories, reasons, and highlights) that can be rendered on the terminal.

### Step 14:

The server transmits the structured response information to the terminal.

The server embeds the response information into a response message, sets appropriate headers (for example, content type and encoding), and sends the message over the network using a response channel corresponding to the original request.

The input to this step is the structured response information from Step 13.

The server serializes the data, optionally compresses the payload, and outputs a network response message directed to the terminal.

### Step 15:

The terminal receives the response message and prepares the display.

The terminal parses the received message, extracts the structured response information, and maps the fields (such as categories, explanations, and comparisons) to user interface components.

The input to this step is the network response message from Step 14.

The terminal performs deserialization and parsing operations and outputs a set of display-ready elements, such as lists, labels, and text blocks, which are arranged according to a predefined layout.

### Step 16:

The terminal displays the listable and comparable information to the user.

The terminal renders multiple policies or promises in a structured view, shows categories as labels or columns, and presents generated explanations or comparisons as readable text.

The input to this step is the set of display-ready elements from Step 15.

The terminal executes drawing operations on the display device, positions UI components, and outputs a visual presentation that enables the user to view, compare, and interpret the classification results and explanations.

### Step 17:

The user reviews the displayed information and issues an additional inquiry if needed.

The user inspects the categories, explanations, and comparisons shown on the terminal, may select filters such as “energy” or “environment,” and may enter a new question, for example: “Compare the energy policies of Participant A and Participant B and highlight the main differences.”

The input to this step is the displayed information from Step 16.

The user performs selection and text entry actions on the terminal, and the terminal outputs new inquiry information that is sent back to the server, thereby initiating a new cycle through the preceding steps with updated input.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented information systems that support users in understanding election-related information, public policies, or product attributes typically rely on static retrieval and simple keyword-based search. Such systems merely return pre-stored text or lists of documents and do not dynamically adapt the form or content of the output to the user's situational intent or emotional state. As a result, when users are confronted with complex and voluminous policy documents, pledges, or technical descriptions, existing systems often provide responses that are either too shallow, too dense, or misaligned with the user's level of understanding and concerns. This leads to increased cognitive load, slower decision making, and reduced trust in the system output.

Furthermore, in many cases the source information exists as unstructured or semi-structured data, such as scanned bulletins, pamphlets, or printed product leaflets, which must be converted, classified, and indexed before any meaningful comparison or interactive explanation can be provided. Existing architectures generally treat optical character recognition, natural language processing, database storage, and any downstream generative processing as isolated components. They do not tightly integrate these components into a feedback loop that uses structured representations and user emotion data to construct optimized prompts for a generative artificial intelligence model. Consequently, system resources such as processing throughput, network bandwidth, and memory are not efficiently utilized, because large quantities of irrelevant or poorly contextualized text are sent to generative models, which increases latency and cost while degrading answer quality.

Additionally, conventional dialogue systems with generative models usually accept raw user queries and context, but they do not systematically derive and maintain a structured “policy/issue space” or “product attribute space” that can be searched and selectively embedded into prompts. Nor do they algorithmically adjust generation parameters, answer detail level, or explanation style in response to real-time emotion analysis. The absence of a standardized mechanism for composing prompt sentences from structured information, user intent, and emotion leads to non-deterministic behavior, unstable answer quality, and difficulty in scaling the system to large and dynamic corpora.

In real-world environments such as physical stores or service locations, these limitations become more severe. Personnel need to obtain concise, accurate, and context-appropriate explanations in real time while interacting with customers. Existing systems cannot reliably transform multimodal inputs (images, speech) into structured knowledge and then into tailored generative responses under strict latency constraints. Therefore, there is a need for an improved computer-implemented system and control method that: (i) efficiently converts unstructured election or product information into structured, comparable records; (ii) detects user intent and emotional state; (iii) automatically composes optimized prompt sentences for a generative AI model using such structured information and emotion context; and (iv) thereby improves overall system responsiveness, relevance, and usability over conventional information retrieval and dialogue systems.

The specific processing by the specific processing unit 290 of the data processing device 12 in Application Example 2 is realized by the following means.

The present invention provides a server comprising a processor configured to acquire an information medium including election-related or other domain-specific information, extract character information from image data included in the information medium by an optical character recognition technique, preprocess the character information by a natural language processing technique to segment the character information and to extract descriptions relating to policies, pledges, products, or services, classify the extracted descriptions by a machine learning model based on a plurality of classification criteria to generate structured information organized by subject and by issue, store and manage the structured information in a storage device as listable and comparable information searchable by identifiers, determine a user's intention and target of interest from user input by a natural language processing technique, analyze an emotional state of the user from the user input by an emotion analysis technique and hold the emotional state as context information, search the structured information based on the intention and the target of interest to extract related information, automatically generate a prompt sentence for a generative artificial intelligence model based on the related information and the context information including the emotional state so as to instruct contents and representation style of an answer generation task, input the prompt sentence to the generative artificial intelligence model to obtain a candidate answer expressed in a natural language, adjust a content or a level of detail of the candidate answer according to the emotional state to generate answer information, and transmit the answer information and associated structured information to a terminal device for presentation to the user. This enables the computing system to transform heterogeneous unstructured inputs into optimized prompts and emotion-aware generative outputs in a resource-efficient and latency-reduced manner, thereby improving the technical operation of the server and associated networked devices in providing context-appropriate, comparable, and dynamically tailored information beyond the capabilities of conventional retrieval and dialogue systems.

The term “information medium” refers to any tangible or intangible data source in which election-related information, policy information, pledge information, product information, or service information is recorded, including but not limited to printed documents, bulletin sheets, pamphlets, leaflets, images, and electronic documents.

The term “image data” refers to digital data representing a visual pattern, including at least one frame or page containing characters or figures, which can be processed by an optical character recognition technique to extract character information.

The term “character information” refers to textual data obtained by converting characters contained in image data into a machine-readable text representation by an optical character recognition technique.

The term “optical character recognition technique” refers to a computerized processing technique that analyzes image data, detects character regions, identifies character shapes, and converts the detected characters into corresponding coded text data.

The term “natural language processing technique” refers to a computerized processing technique that analyzes and manipulates human language text, including one or more operations such as tokenization, sentence segmentation, part-of-speech tagging, syntactic parsing, semantic analysis, entity extraction, and intent detection.

The term “preprocess the character information” refers to performing at least tokenization, sentence segmentation, normalization, and noise removal on character information so that the character information becomes suitable for subsequent extraction, classification, and analysis.

The term “sentence unit” refers to a segment of text that the system treats as a complete sentence or clause for the purpose of linguistic analysis and classification.

The term “word unit” refers to a segment of text corresponding to a single token, word, or morpheme as defined by a tokenization or morphological analysis process.

The term “description relating to a policy or a pledge” refers to a portion of text that expresses a proposed action, plan, objective, commitment, or promise of a subject, such as a candidate, organization, or entity, regarding governance, public issues, or other decision-relevant matters.

The term “machine learning model” refers to a parameterized computational model trained on data to perform tasks such as classification, prediction, or clustering, including but not limited to neural networks, support vector machines, decision trees, and ensemble models.

The term “classification criteria” refers to one or more rules, labels, dimensions, or features used by the machine learning model to assign descriptions to categories, such as subject, issue type, attribute type, or relevance level.

The term “subject” refers to an entity that is associated with a policy, pledge, product, or service, including but not limited to a candidate, organization, corporate body, or other actor.

The term “issue” refers to a thematic topic or problem category that describes a domain or aspect of a policy, pledge, product, or service, such as environment, economy, education, safety, or reliability.

The term “structured information” refers to data that has been organized into an explicit schema, such as records containing fields for subject, issue, description, identifiers, attributes, and references, allowing efficient search, comparison, and retrieval by a computing device.

The term “storage device” refers to any hardware component or subsystem capable of storing digital data, including but not limited to semiconductor memory, magnetic storage, optical storage, or network-attached storage.

The term “listable and comparable information” refers to structured information that is stored and indexed such that multiple records can be presented concurrently in a list or table and compared with each other along one or more dimensions, such as subject, issue, or attribute.

The term “identifier” refers to a data element, such as a key, code, or label, that uniquely or logically identifies a subject, issue, record, or category for purposes of indexing and searching.

The term “input information” refers to data provided by a user to the system through a terminal device, including but not limited to text input, voice input, selection input, or other interaction data.

The term “intention” refers to an inferred purpose, goal, or information need of the user, such as requesting a summary, requesting a comparison, requesting detailed explanation, or requesting product information.

The term “target of interest” refers to one or more entities, topics, issues, or attributes that are determined to be the focus of the user's intention, such as a specific subject, policy area, or product feature.

The term “emotion analysis technique” refers to a computerized processing technique that analyzes user-generated data, such as text, audio, or image data, to estimate one or more emotional states, such as anxiety, dissatisfaction, anger, joy, or interest.

The term “emotional state” refers to an internal psychological condition of the user, estimated by the emotion analysis technique, that may influence how information should be presented, including but not limited to anxiety, dissatisfaction, anger, confidence, and curiosity.

The term “context information” refers to auxiliary information used to control processing or generation by the system, including at least one of an emotional state, prior interaction history, user profile data, and current task information.

The term “related information” refers to a subset of the structured information that is selected based on the user's intention, target of interest, and identifiers, and that is relevant to answering the user's current query.

The term “generative artificial intelligence model” refers to a computational model that receives an input sequence, such as a prompt sentence, and generates an output sequence expressed in a natural language, by using probabilistic or learned representations, such as a neural language model.

The term “prompt sentence” refers to an input text, provided to the generative artificial intelligence model, that describes at least part of the user's intention, includes related information, and specifies constraints or instructions regarding the content, style, or detail level of the answer to be generated.

The term “answer generation task” refers to a processing operation performed by the generative artificial intelligence model to produce an answer or explanation in natural language based on a prompt sentence and any associated context information.

The term “representation style of an answer” refers to one or more characteristics of an answer's expression, such as tone, level of detail, complexity, politeness, emphasis, or structure.

The term “candidate answer” refers to an initial natural language output generated by the generative artificial intelligence model in response to a prompt sentence, before any post-processing or adjustment is applied by the processor.

The term “answer information” refers to the final natural language content prepared for presentation to the user, obtained by adjusting or augmenting a candidate answer in view of the emotional state and context information.

The term “terminal device” refers to any user-side computing apparatus configured to communicate with the server, including but not limited to a mobile terminal, a wearable terminal, a personal computer, or a kiosk.

The term “display device” refers to a hardware component of a terminal device that visually presents information to a user, including but not limited to a flat panel display, a head-mounted display, or a projection device.

The term “audio output device” refers to a hardware component of a terminal device that outputs audio to a user, including but not limited to a loudspeaker, earphone, or bone-conduction transducer.

The term “question input as voice” refers to an utterance provided by the user and captured as audio data, the utterance including at least one interrogation or request for information.

The term “speech recognition technique” refers to a computerized processing technique that converts audio data representing human speech into corresponding text data using acoustic and language models.

The term “real-world store or service providing environment” refers to a physical location in which products or services are offered to customers, such as a retail shop, showroom, reception desk, or consultation space.

The term “inquiry regarding a product or a service” refers to a question or request for information about attributes, features, usage, safety, reliability, or other aspects of a product or service, submitted by a user through a terminal device.

The term “attribute information of the product or the service” refers to structured data describing one or more characteristics of a product or service, such as specifications, performance, safety standards, certifications, usage conditions, advantages, or limitations.

The term “safety” refers to an aspect of a product, policy, or service relating to the likelihood of causing harm, risk, or adverse effects under expected conditions of use or implementation.

The term “reliability” refers to an aspect of a product, policy, or service relating to the consistency, stability, or predictability of performance over time or under specified conditions.

The term “feature explanation of the product or the service” refers to a natural language description generated for a user that summarizes or details one or more attributes, functions, benefits, or usage scenarios of a product or service.

In an embodiment, a server cooperates with one or more terminal devices operated by a user to implement the claimed system. The server includes at least one hardware processor, a main memory, a non-volatile storage device, and a network interface. The terminal includes at least one processor, a display device, an audio input/output device, and a communication interface. The server and the terminal are connected via a communication network, such as a wired or wireless packet network.

Server executes an operating system and middleware for network communication and data management. Server executes an application program that implements functional modules including an input acquisition module, an optical character recognition module, a natural language processing module, a classification module, a structured information management module, an intent detection module, an emotion analysis module, a prompt generation module, a generative AI interface module, and an answer post-processing and delivery module. Server stores program instructions and model parameters in the storage device. Terminal executes a client application that controls a camera, a microphone, a display device, and a network interface. Terminal acquires image data of election bulletins, policy pamphlets, product leaflets, or service manuals by using the camera and transmits the image data to Server. Terminal acquires user speech through the microphone and transmits audio data to Server, or converts the speech to text locally by using a speech recognition library and transmits the text to Server. Terminal presents answer information and structured comparison information delivered from Server by rendering text, tables, and graphical elements on the display device and, when appropriate, by converting text to audio via a text-to-speech engine. Server uses an optical character recognition engine to convert image data into character information. In one embodiment, Server uses a general-purpose optical character recognition library that performs binarization, line detection, character segmentation, and character classification using a convolutional neural network. Server receives, from the optical character recognition engine, a set of recognized strings for each text region, together with location coordinates. Server normalizes the recognized strings by removing artifacts, correcting character encoding, and unifying punctuation. This explicit conversion from image data to normalized character information enables Server to treat paper-based election bulletins and leaflets as machine-readable textual records without requiring manual transcription.

Server applies a natural language processing module to the normalized character information. In an embodiment, Server uses a natural language processing library that implements tokenization, sentence segmentation, part-of-speech tagging, and syntactic dependency parsing. Server segments the character information into sentence units and word units. Server uses linguistic patterns and domain-specific dictionaries to identify descriptions relating to policies, pledges, products, or services. For example, Server identifies sentences containing expressions equivalent to “will implement”, “promises to introduce”, “policy on”, “feature of”, or “this product provides”. Server marks each such sentence as a description candidate and extracts it into an intermediate data structure that contains at least the sentence text, the source document identifier, positional metadata, and language metadata.

Server classifies the extracted descriptions by using a machine learning model. In an embodiment, Server uses a neural network classifier implemented with a multi-layer architecture that includes an input embedding layer, one or more recurrent or transformer layers, and a fully connected output layer. Server converts each sentence into a vector representation using word embeddings or subword embeddings. Server feeds the vector representation into the neural network classifier, which outputs a probability distribution over classification criteria such as subject category and issue category. Server trains the neural network classifier in advance by using labeled training data that associates policy sentences and product descriptions with known categories such as environment, economy, education, safety, reliability, and cost. During training, Server minimizes a cross-entropy loss function by updating neural network weights using stochastic gradient descent or a variant such as Adam. Server optionally uses data augmentation techniques such as synonym replacement or paraphrasing to increase robustness of the classifier. This design allows Server to automatically and consistently assign categories to new descriptions that differ from training samples, thereby improving classification accuracy compared to rule-only systems. Server records the classified descriptions as structured information. In an embodiment, Server stores each description in a relational database table having fields such as description_id, subject_id, issue_id, text, source_id, and classification_confidence. Server also maintains index structures on subject_id and issue_id to support efficient search and comparison queries. Server provides additional structures such as summary tables that group descriptions by subject and by issue to generate listable and comparable views. By computing and storing aggregate views, Server reduces repeated computation for frequent queries and decreases query latency.

Server acquires input information from the user through the terminal device. The input information includes at least a natural language query expressed in text or speech. In an embodiment, Terminal transmits raw audio of the query to Server. Server uses a speech recognition engine that performs acoustic feature extraction, phoneme decoding, and language model scoring to generate text corresponding to the user's utterance. Server forwards the resulting text to the natural language processing module.

Server determines a user's intention and target of interest from the input text. In an embodiment, Server uses a separate neural network-based intent detection model. The model receives as input a sentence representation of the query and outputs an intent label, such as “request_summary”, “request_comparison”, “request_detail”, “request_product_feature”, or “request_safety_explanation”. The model also outputs attention scores or slot predictions that indicate specific entities or topics mentioned in the query, such as a candidate name, an issue area (for example environment or economy), or a product identifier. Server interprets these outputs as the target of interest. Because the intent detection model is trained with supervised labels and uses internal feature representations that capture syntactic and semantic patterns, Server can correctly detect intent even when the user uses indirect or colloquial language, improving the precision of downstream processing.

Server analyzes the emotional state of the user from the input information. In an embodiment, Server applies an emotion analysis model that uses a neural network architecture similar to that of the classifier but with output labels such as “anxiety”, “dissatisfaction”, “anger”, “neutral”, and “positive”. Server computes a probability score for each emotion and selects one or more dominant emotions above a threshold. Server records the emotional state and, optionally, a numeric confidence score into a context data structure associated with the current interaction session. In variants, Server also processes prosodic features extracted from the speech signal or facial features captured by a camera, and combines them with textual features through a multimodal fusion layer in the emotion analysis model. These emotion detection mechanisms enable Server to adapt subsequent information generation and presentation more precisely than simple rule-based sentiment scoring.

Server searches the structured information based on the detected intention and target of interest. For example, when the user's intention is “request_comparison” and the target of interest includes a particular issue, Server issues a query to the relational database to retrieve all descriptions associated with that issue for multiple subjects. When the intention is “request_safety_explanation” for a product, Server retrieves descriptions classified into safety and reliability-related categories for the relevant product or service. Server constructs a structured context object that groups the retrieved descriptions by subject and by issue and that contains metadata such as classification confidence and recency.

Server generates a prompt sentence for a generative AI model based on the structured context and the context information including the emotional state. In an embodiment, Server uses the prompt generation module to compose an instruction portion and a context portion. The instruction portion encodes the answer generation task and the desired representation style, such as level of detail, tone, and emphasis. The context portion encodes relevant structured information in a human-readable but compact form. For example, Server generates a prompt sentence such as:
“Analyze the following policies on environmental issues of multiple candidates and explain the differences in simple terms for a first-time voter: [policy of subject A], [policy of subject B].”

When the user's emotional state is classified as anxiety regarding safety, Server generates a prompt sentence such as:
“The user is anxious about the safety of the following product. Using the specification and safety descriptions below, generate an explanation that emphasizes safety and reliability and avoids technical jargon: [product attributes and safety notes].”

When the user expresses dissatisfaction with a policy, Server generates a prompt sentence such as:
“The voter is dissatisfied with the following policy description. Explain the background, objectives, and expected benefits of this policy in a calm and respectful tone, and address common concerns: [policy text].”

Server may also generate prompt sentences such as:
“Compare the economic policies of subject A and subject B, and summarize the key differences in taxation and employment in a concise manner suitable for a non-expert.” “Explain the main features of this product, with emphasis on durability, battery life, and ease of use, based on the attribute data provided: [feature list].”

Server thereby transforms structured, indexed data into a targeted natural language instruction that guides the generative AI model to focus on relevant aspects and to output an answer in a form that matches the user's needs and emotional state. Because Server uses explicit structured context and emotion parameters, the prompt generation process is not a mere direct pass-through of user input, but a non-conventional composition procedure that improves output stability and computational efficiency.

Server interfaces with a generative AI model through the generative AI interface module. In an embodiment, the generative AI model is implemented as a large-scale neural language model with transformer layers, multiple attention heads, and positional encodings. Server provides the prompt sentence as a sequence of tokens to the generative AI model and configures decoding parameters such as maximum output length, temperature, and nucleus sampling probability. Server receives from the model a candidate answer, i.e., a sequence of tokens that is decoded into a natural language string.

Server post-processes the candidate answer to generate answer information. Server may segment the answer into logical sections, insert headings, or add labels indicating which subject or issue each part addresses. Server may compare the candidate answer with the emotional state and adjust the answer content or level of detail. For example, if the emotional state indicates anxiety, Server may reduce the level of technical detail and add explicit reassurances that are grounded in retrieved safety data; if the emotional state indicates dissatisfaction, Server may include more background information and explicit acknowledgment of concerns. In some embodiments, Server may re-issue a refined prompt sentence with additional constraints if the initial candidate answer is judged to be insufficiently aligned with the context, thereby forming a closed-loop adjustment process that improves answer quality while minimizing unnecessary inference runs by the generative AI model.

Server transmits the answer information and at least a subset of the structured information used to generate the answer to the terminal device. Terminal displays the answer in a format suited to the device form factor. For a smartphone, Terminal may display a text answer at the top and a comparison table below; for a head-mounted display, Terminal may overlay concise labels for “environment policy” and “economic policy” near the regions of the physical pamphlet corresponding to the respective descriptions. Terminal may also read the answer aloud by using a text-to-speech engine so that the user can receive information hands-free. This integration of structured information and generative answer text improves the user's ability to verify and understand the generated content.

This system architecture improves computer technology itself rather than merely automating a human reading task. Server performs an integrated pipeline that includes (i) OCR-based conversion of paper or image documents into normalized character information; (ii) neural-network-based classification into structured, indexed records; (iii) intent and emotion detection; and (iv) controlled prompt sentence composition for a generative AI model. By pre-structuring and indexing the corpus, Server avoids sending entire raw documents to the generative AI model for every query, thus reducing network traffic between Server and the generative AI model host, reducing inference input length, and decreasing overall latency. Because the prompt sentence is constructed from already filtered and categorized pieces of information, the generative AI model receives a more focused context, which increases answer relevance and reduces the probability of irrelevant or hallucinated content.

Server also reduces storage and computation overhead by storing representations in normalized table structures and precomputed category indices. Queries using identifiers and issues can be executed efficiently using database indices. The classification and emotion analysis models are trained offline and deployed as optimized inference graphs, allowing high-throughput, low-latency operation on commodity server hardware. Compared to systems that repeatedly perform full-text search and free-form generation, this design yields measurable improvements in processing speed, memory usage, and network utilization.

The described use of machine learning models is not limited to abstract judgment. Server defines specific architectures and learning procedures for the classification and emotion analysis models, including loss functions, weight update rules, and data augmentation strategies. These design choices result in technical effects such as higher classification accuracy, robust emotion detection across varied phrasing, and stable prompt generation behavior. The structural separation between the classifier, intent detector, and emotion analysis model allows Server to reuse intermediate features and to share embeddings, further improving calculation efficiency.

In some embodiments, Server applies rule-based post-processing layers on top of neural outputs to enforce domain constraints, such as ensuring that each prompt sentence references only those subjects and issues that have structured records in the database. This hybrid rule-and-learning approach deviates from conventional free-form generative systems and reduces errors that would otherwise occur due to unconstrained generation.

Server may be implemented in alternative configurations. In one variation, Server executes some or all of the natural language processing and classification locally on the terminal device when the terminal has sufficient processing capability, thereby reducing network load. In another variation, Server uses different neural network architectures, such as convolutional sequence models or smaller transformer models, when resource constraints or latency requirements demand. In yet another variation, Server extends the structured information schema to additional domains such as legal documents or technical manuals, while preserving the same pipeline of OCR, classification, intent and emotion detection, and prompt sentence generation.

User interacts with the system by capturing real-world documents, speaking or typing queries, and reviewing generated explanations. Because the system converts unstructured, multimodal inputs into structured, indexed data and then uses that data to drive a generative AI model through a non-conventional prompt sentence generation mechanism, the system produces answers with improved technical characteristics in terms of speed, consistency, and resource usage. As a result, the system achieves a concrete technical improvement in computer operation, rather than a mere automation of human evaluation or reading, and provides a robust platform for real-time, context-aware explanations of policies, pledges, products, and services.

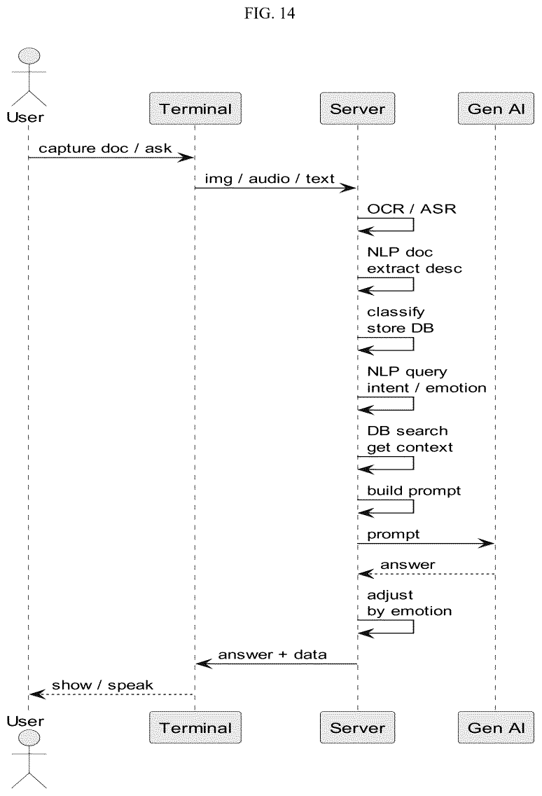

The following describes the processing flow using FIG. 14.

### Step 1:

User operates the terminal to provide input.

User points the terminal camera at a bulletin, pamphlet, product leaflet, or other document and presses a capture button, or User speaks a question into the terminal microphone, or User types a question into a text input field.

Input is a physical document, spoken utterance, or typed query; output is digital image data, audio data, or text data stored in the terminal.

Terminal activates the camera sensor to capture at least one frame and stores the frame in a buffer as image data, activates the microphone to record audio samples and stores them as audio data, or records keystrokes to generate text data.

### Step 2:

Terminal transmits the captured data to the server.

Terminal packages the image data, audio data, and/or text data together with metadata such as device identifier, timestamp, and language setting into a network request and sends the request to Server via a communication interface.

Input is buffered image, audio, or text data; output is a network message delivered to Server. Terminal constructs an HTTP or similar request body including encoded binary data or text and transmits this over a wired or wireless network link to a predefined server address.

### Step 3:

Server receives and stores the raw input data.

Server accepts the incoming request, parses protocol headers, and separates payload segments into image data, audio data, and text data, and then stores each segment temporarily in a memory buffer or storage device with an associated request identifier.

Input is the network message from Terminal; output is stored raw data objects (image objects, audio objects, text objects) associated with a session record.

Server logs the receipt event and records request metadata so that subsequent processing modules can access the correct data.

### Step 4:

Server converts image data to character information by using an optical character recognition technique.

Server detects that image data is present, selects an optical character recognition engine, and sends the image pixels for processing.

Input is image data; output is character information representing recognized text strings with positions.

Server performs image preprocessing such as grayscale conversion and noise reduction, segments the image into text regions, recognizes character shapes, and converts them into encoded characters, then aggregates recognized characters into lines and paragraphs to form normalized text.

### Step 5:

Server converts audio data to text by using a speech recognition technique.

Server detects that audio data is present, selects a speech recognition engine, and sends the audio samples for decoding.

Input is audio data representing the user's voice; output is transcription text representing the spoken question.

Server computes acoustic features such as spectrograms, matches them to phonetic models, applies a language model to select the most probable word sequence, and outputs textual transcription for subsequent language analysis.

### Step 6:

Server unifies all textual inputs for further language processing.

Server collects text obtained from optical character recognition, text obtained from speech recognition, and any text originally input by Terminal and merges them into a single text object with source labels.

Input is character information from optical character recognition, transcription text from speech recognition, and direct text input; output is a combined text dataset with annotations indicating origin and content type.

Server stores this combined text in memory and prepares pointers for downstream modules so each module can access the relevant portion (for example, document text versus user query text).

### Step 7:

Server preprocesses the document text and extracts description candidates.

Server applies a natural language processing module to the document portion of the combined text to perform tokenization, sentence segmentation, and basic normalization. Input is document text from optical character recognition; output is a list of sentence units and word units with grammatical tags.

Server analyzes each sentence to detect patterns indicating policies, pledges, features, or attributes, marks those sentences as description candidates, and creates data records containing sentence text, source identifiers, and position information.

### Step 8:

Server classifies description candidates into structured categories.

Server feeds each description candidate into a machine learning classifier that predicts categories such as subject and issue.

Input is a set of description candidate sentences; output is a set of records where each sentence is labeled with subject category and issue category, each with confidence scores. Server converts each sentence into numerical feature vectors, processes the vectors through the classifier network, obtains probability distributions over predefined labels, selects labels above thresholds, and attaches the labels to the corresponding description records.

### Step 9:

Server stores categorized descriptions as structured information.

Server writes each labeled description record into a structured database table, using fields such as subject identifier, issue identifier, sentence text, and classification confidence.

Input is labeled description records; output is persistent structured information stored in indexed tables.

Server creates or updates indices on subject and issue columns, builds or refreshes aggregate views that group descriptions by subject and issue, and ensures that future queries can retrieve relevant information efficiently.

### Step 10:

Server preprocesses the user's query text for intent and entity analysis.

Server selects the portion of the combined text that corresponds to the user's question, and applies natural language processing such as tokenization, sentence segmentation, and part-of-speech tagging.

Input is the user's query text; output is a tokenized and annotated representation of the query. Server extracts potential entity mentions such as candidate names, issue keywords, or product identifiers by using dictionary lookup or named-entity recognition algorithms.

### Step 11:

Server detects the user's intention and target of interest.

Server passes the annotated query text through an intent detection model that outputs an intent label and associated entities or slots.

Input is the annotated query representation; output is an intent label (for example request_summary, request_comparison, request_detail, request_product_feature, request_safety_explanation) and a target set including specific subjects, issues, or products. Server computes feature embeddings for the query, applies the intent model to derive a probability distribution over possible intents, selects the highest scoring intent, and maps slot predictions to structured identifiers for use in database queries.

### Step 12:

Server analyzes the user's emotional state from the input information.

Server sends the user's query text and, optionally, derived acoustic or other features to an emotion analysis model that predicts emotion labels and scores.

Input is user-generated data including text and possibly prosodic features; output is an emotional state label such as anxiety, dissatisfaction, or neutral, along with a confidence value.

Server fuses multimodal signals, calculates emotion probabilities, selects dominant emotions above a threshold, and stores the resulting emotional state and scores into a context object linked to the current interaction.

### Step 13:

Server retrieves relevant structured information based on intent and target.

Server constructs and executes database queries that filter structured description records by subject identifiers, issue identifiers, or product identifiers indicated by the target of interest and appropriate to the user's intention.

Input is the intent label, target set, and structured information database; output is a collection of relevant description records and associated metadata.

Server uses indexed queries to fetch records, arranges them into grouped sets by subject and issue, and may compute summaries or ordering based on recency or classification confidence.

### Step 14:

Server constructs a structured context for prompt generation.

Server transforms the retrieved description records into a context object that contains text excerpts, subject labels, issue labels, and any additional attributes needed for explanation. Input is the collection of relevant description records; output is a structured context object ready to be embedded into a prompt sentence.

Server truncates or prioritizes descriptions when necessary to fit within a size limit, concatenates selected sentences, and marks each group with headings or annotations for later inclusion in the prompt.

### Step 15:

Server generates a task-specific prompt sentence for the generative AI model.

Server uses the intent, target, structured context, and emotional state to compose a natural language instruction and associated context text.

Input is the intent label, target information, structured context, and emotional state; output is a prompt sentence or prompt text block that encodes the answer generation task and desired answer style.

Server selects a template or generation rule based on the intent, inserts target and context segments, and modifies language to reflect the emotional state, for example by including instructions to emphasize safety and reliability or to provide additional background.

Server may produce prompt text such as: “Analyze the following policies and compare them in simple terms for a first-time voter: [context]” or “The user is anxious about the safety of the following product. Using the specification below, generate an explanation that emphasizes safety and reliability: [context].”

### Step 16:

Server submits the prompt sentence to the generative AI model and obtains a candidate answer.

Server transmits the prompt text as a sequence of tokens to the generative AI model and configures decoding parameters.

Input is the prompt sentence; output is a candidate answer text generated by the model. Server encodes the prompt into token IDs, requests an output sequence from the generative AI model under specified constraints such as maximum length and sampling strategy, receives the returned token sequence, and decodes it into a human-readable answer string.

### Step 17:

Server post-processes and adjusts the candidate answer according to the emotional state and context.

Server analyzes the candidate answer in view of the previously determined emotional state and relevant structured information, and modifies or augments the answer if needed.

Input is the candidate answer text and the emotional state with context; output is finalized answer information tailored to the user.

Server may split the answer into smaller sections, add headings, insert explicit references to policies or features from the context, and adjust wording or level of detail. When necessary, Server may generate additional sentences or slightly rephrase portions so that the answer emphasizes reassurance or detail in accordance with the emotional state.

### Step 18:

Server packages the answer information and supporting structured information for delivery. Server combines the finalized answer text with selected structured records that support or illustrate the answer, formatting them in a response message suitable for display or audio output at the terminal.

Input is answer information and selected structured description records; output is a formatted response payload.

Server creates data fields for main answer text, comparison tables, category tags, and any optional metadata, and ensures that the size and structure of the payload conform to protocol and device capabilities.

### Step 19:

Server transmits the response payload to the terminal.

Server sends the formatted response through the network interface back to the originating terminal device using a reliable communication protocol.

Input is the response payload; output is a network message containing answer and context data delivered to Terminal.

Server records transmission status and timing information and, if an error occurs, may retry or fall back to a simplified response.

### Step 20:

Terminal presents the answer information and structured information to the user.

Terminal receives the response payload, parses it, and renders the included content on the display device or through audio output.

Input is the response payload from Server; output is a visual and/or auditory presentation for User.

Terminal displays the main answer text, shows additional elements such as side-by-side comparisons or category labels, and optionally invokes a text-to-speech engine to read the answer aloud.

User views or listens to the presented information and, based on that information, may decide to issue a follow-up question, in which case the process can be repeated beginning from the initial steps.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

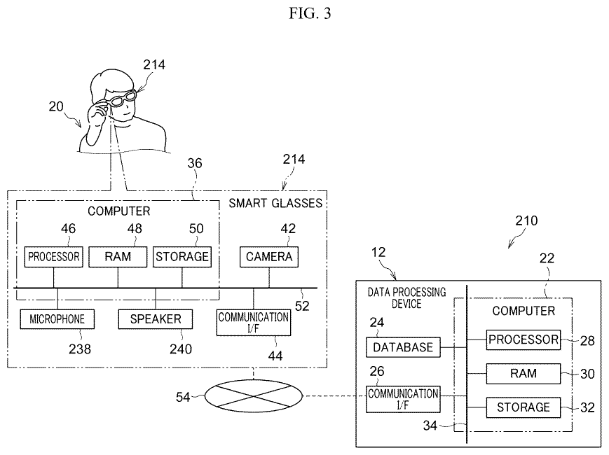

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

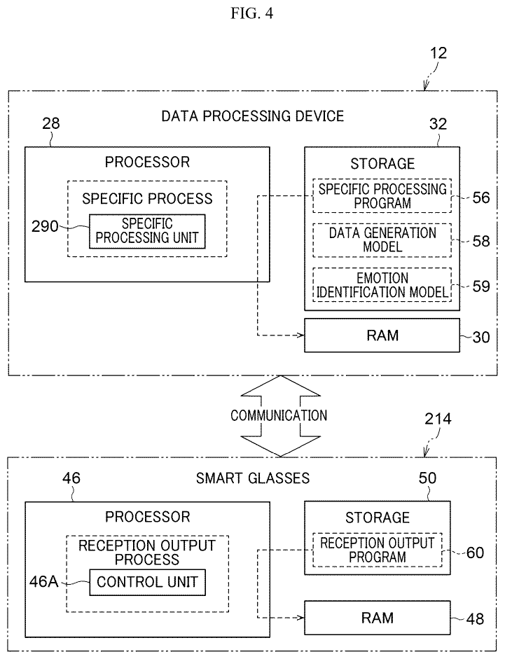

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

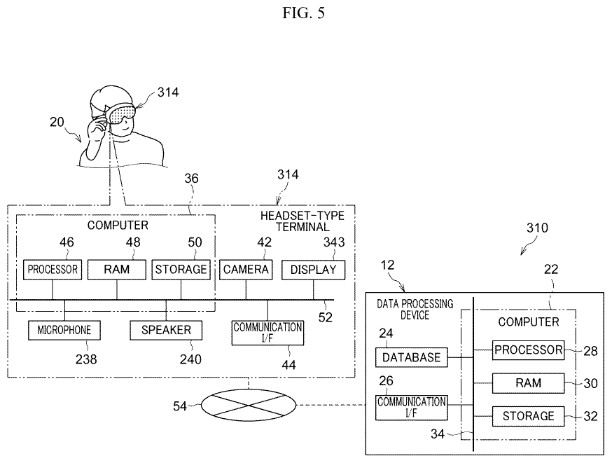

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

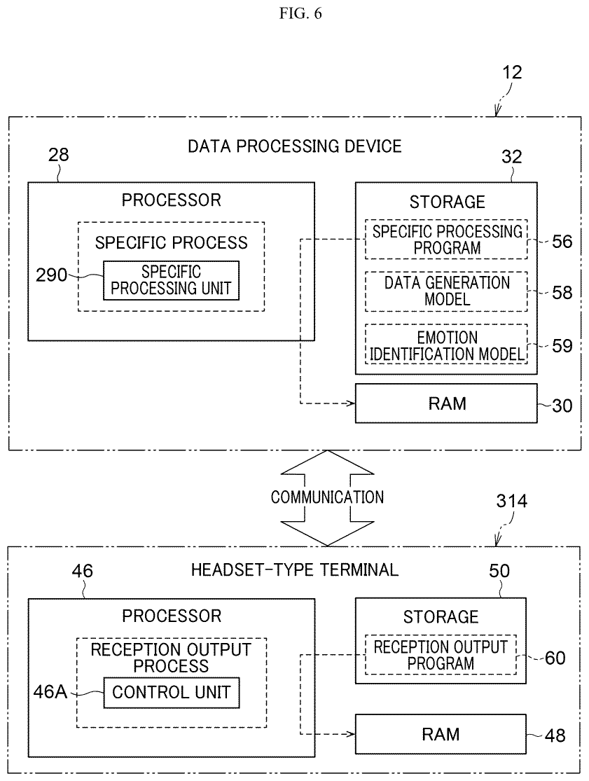

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

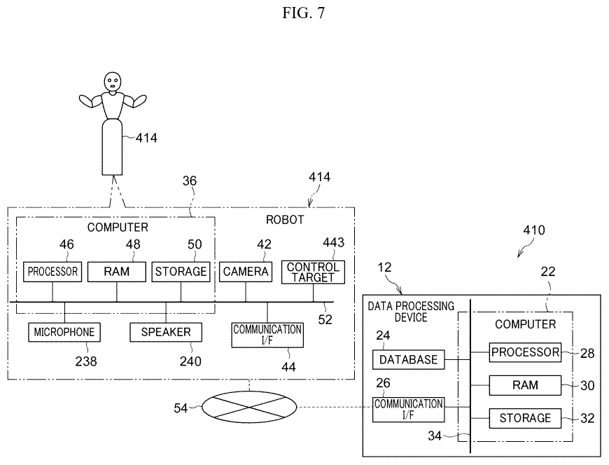

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

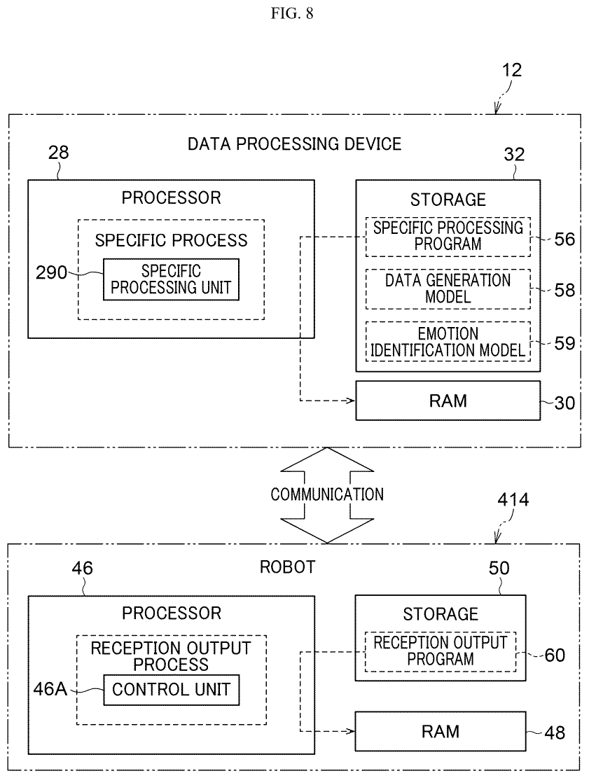

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

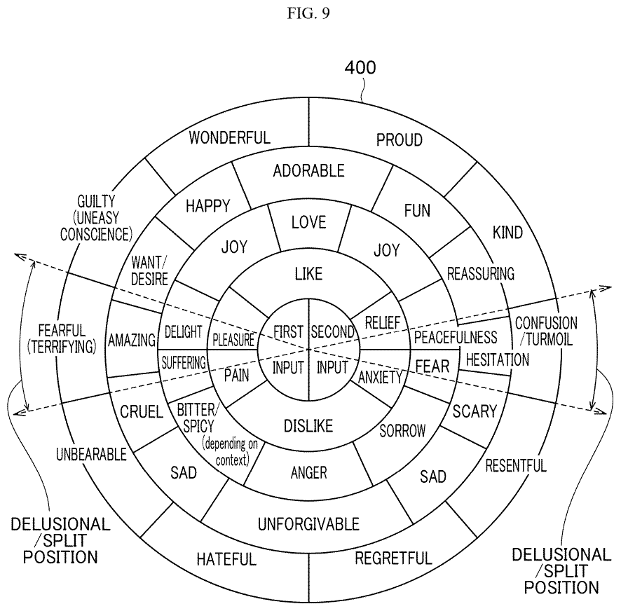

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

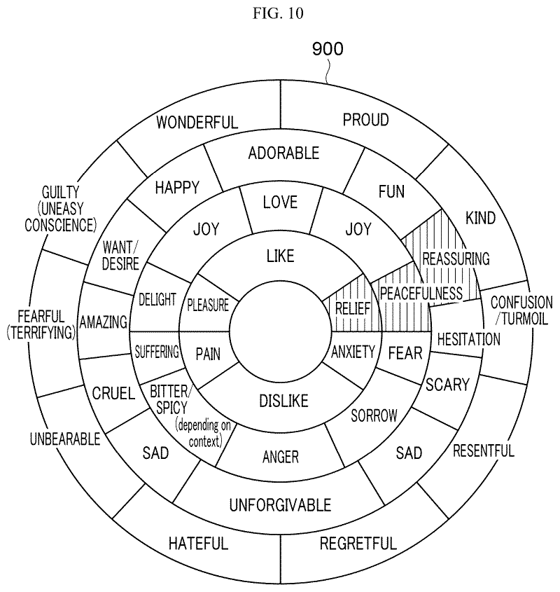

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, via an input device, an electronic file including election-related information from a user terminal, analyze a format of the electronic file, extract text information from the electronic file in accordance with the analyzed format, and convert the extracted text information into normalized text by removing unnecessary symbols and whitespace, and perform language analysis processing on the normalized text by using natural language processing technology to detect expressions indicating a candidate, specify a speaking subject based on the detected expressions, and extract, for each speaking subject, sentences corresponding to a policy or a promise, and
assign, to each extracted sentence, an issue classification representing an election issue and a type classification representing whether the sentence is a policy or a promise, based on a classification rule or a trained classification model, and generate structured data as association information between a candidate and the issue classification, and
store the structured data in a database management device and manage the structured data so as to be searchable by candidate and by issue classification, and
generate comparison information for display on the user terminal by acquiring, based on the structured data, policies or promises of a plurality of candidates on an issue-by-issue basis in a list-comparable format in accordance with an issue classification designated by a user, and generate a prompt sentence for input to a generative information processing model by using a template or string operation based on at least one of the structured data and the comparison information, and input the prompt sentence to the generative information processing model so as to instruct the generative information processing model to generate an answer related to the policies or promises of the candidates.

### (Supplementary 2)

The system according to supplementary 1,
wherein the processor is configured to
select, from the structured data, representative sentences for each candidate corresponding to an issue classification designated by the user, embed the representative sentences as contextual information together with a candidate identifier and the issue classification into the prompt sentence, and thereby instruct the generative information processing model to generate an answer explaining differences and commonalities among the candidates.

### (Supplementary 3)

The system according to supplementary 1,
wherein the processor is configured to
use classification results of the policies or promises obtained from the structured data to add, to the prompt sentence, a description specifying a neutral and user-friendly explanatory format, comparison viewpoints, and an output style, and thereby control an expression format of the answer generated by the generative information processing model.

### Application Example 1

### (Supplementary 1)

A system comprising a processor,
wherein the processor is configured to
acquire, from election-related document information, candidate assertion information as electronic character information by using image recognition processing and character recognition processing,
analyze the acquired electronic character information by using natural language processing to perform syntactic analysis and semantic analysis, extract policy information for each candidate, and record the policy information as structured data on the basis of classification information and search information associated with issues of public concern,
store the structured data in a relational information management device and generate index information associated with candidate information, issue information, and policy information, retrieve, on the basis of issue designation information or candidate designation information received from an information terminal device, corresponding policy information from the relational information management device, format the policy information into a list-comparable format by candidate or by issue, and transmit the formatted policy information to the information terminal device,
automatically generate a prompt sentence to be input to a generative information processing model on the basis of the structured data and question information acquired from a user, and instruct the generative information processing model to execute response generation processing, and
associate response information acquired from the generative information processing model with display information for presenting the response information together with the list-comparable format, and transmit the associated information to the information terminal device.

### (Supplementary 2)

The system according to supplementary 1,
wherein the processor is configured to
extract, on the basis of the issue designation information or the candidate designation information received from the information terminal device, relevant policy information from the structured data formatted into the list-comparable format, automatically generate a prompt sentence including an explanatory text that cites the extracted policy information, and input the prompt sentence to the generative information processing model to cause the generative information processing model to generate response information including a comparative explanation to a question of the user.

### (Supplementary 3)

The system according to supplementary 1,
wherein the processor is configured to
perform sentiment analysis on the question information and operation history information acquired from the information terminal device, and adjust an expression style or a detail level of the prompt sentence to be input to the generative information processing model on the basis of a result of the sentiment analysis so as to cause the generative information processing model to generate response information corresponding to a comprehension level or an interest level of the user.

### Example 2

### (Supplementary 1)

A system comprising a processor,
wherein the processor is configured to
acquire character information from an information medium in which information regarding policies or promises is recorded, by using an acquisition device connected to an information processing apparatus, and acquire text data from the character information by using an optical character recognition technique or a text input technique,
perform preprocessing on the text data, the preprocessing including morphological analysis, token segmentation, removal of unnecessary terms, and stemming, and organize the policies or promises into a listable and comparable form by associating the preprocessed text data with identifiers and classification information based on a natural language processing technique so as to focus the information,
generate a prompt sentence including a classification instruction, an explanation instruction, or a comparison instruction based on the preprocessed text data and the identifiers or the classification information, and input the prompt sentence as a part of input data to a generative information processing model,
convert a classification result, explanation information, or comparison result obtained from the generative information processing model into response information in a format understandable to a user, and generate the response information so as to be output to a display device, and
store the response information based on the identifiers or the classification information, and provide the stored response information as an intelligent service that presents a plurality of policies or promises in the listable and comparable form.

### (Supplementary 2)

The system according to supplementary 1,
wherein the processor is configured to
generate, based on inquiry information acquired from the user and the information organized into the listable and comparable form, a prompt sentence including an extraction result of a policy or promise corresponding to the inquiry information, and input the prompt sentence to the generative information processing model so as to generate the response information to a question from the user.

### (Supplementary 3)

The system according to supplementary 1,
wherein the processor is configured to
execute sentiment analysis on the text data and the inquiry information acquired from the user, and adjust a tone, a degree of detail, or an output format of the prompt sentence to the generative information processing model based on a result of the sentiment analysis so as to control contents of the response information generated by the generative information processing model.

### Application Example 2

### (Supplementary 1)

A system comprising a processor,
wherein the processor is configured to
acquire an information medium in which election-related information is recorded,
extract character information from image data included in the information medium by using an optical character recognition technique,
preprocess the character information by using a natural language processing technique, segment the character information into sentence units and word units, and extract descriptions relating to a policy or a pledge,
classify the extracted descriptions, by using a machine learning model, based on a plurality of classification criteria, and record the descriptions as structured information organized for each subject and for each issue,
store the structured information in a storage device and manage the structured information as listable and comparable information that is searchable by using the subject or the issue as an identifier,
acquire input information from a user and specify an intention and a target of interest of the user by using a natural language processing technique,
apply an emotion analysis technique to the input information to specify an emotional state of the user and hold the emotional state as context information,
search the structured information based on the intention and the target of interest and extract related information corresponding to the subject and the issue,
generate a prompt sentence to be input to a generative artificial intelligence model based on the related information and the context information including the emotional state, the prompt sentence instructing contents of an answer generation task and a representation style of an answer,
input the prompt sentence to the generative artificial intelligence model to obtain a candidate answer expressed in a natural language, and generate answer information by adjusting contents or a level of detail of the candidate answer according to the emotional state, and transmit the answer information and, among the structured information, information corresponding to the subject and the issue to a terminal device, and present the information to the user via a display device or an audio output device of the terminal device.

### (Supplementary 2)

The system according to supplementary 1,
wherein the processor is configured to
acquire a question input as voice from the user, convert the voice into text data by using a speech recognition technique, input the text data to the intention specifying and emotional state specifying, and generate the prompt sentence based on the text data so as to cause the generative artificial intelligence model to perform answer generation.

### (Supplementary 3)

The system according to supplementary 1,
wherein the processor is configured to
in a real-world store or service providing environment, acquire an inquiry from the user regarding a product or a service via the terminal device, store attribute information of the product or the service as part of the structured information, adjust the prompt sentence so as to emphasize an explanation regarding safety or reliability in accordance with the emotional state, and instruct the generative artificial intelligence model to generate the answer information including a feature explanation of the product or the service.

What is claimed is:

1. A system comprising:
circuitry configured to:
receive, via a communication interface coupled to a packet-switched network, electronic files from a terminal device, analyze formats of the electronic files, extract text information from the electronic files based on the analyzed formats, and normalize the extracted text information by removing unnecessary symbols and whitespace;
perform natural language processing on the normalized text information to detect subject-indicating expressions, specify speaking subjects based on the detected expressions, and extract, for each speaking subject, sentences corresponding to declarative statements;
classify the extracted sentences into category classifications and statement type classifications according to classification rules or a trained classification model, generate structured data representing association information between speaking subjects and category classifications, and store the structured data in a storage device such that the structured data is searchable by speaking subject and by category classification;
retrieve, in response to a query from the terminal device specifying a category classification, declarative statements of a plurality of speaking subjects for the specified category classification from the structured data, and generate comparison data in a list-comparable format for transmission to the terminal device via the communication interface; and
generate a prompt sentence based on at least one of the structured data and the comparison data, transmit the prompt sentence to a generative model via the communication interface, and transmit an answer received from the generative model to the terminal device via the communication interface.

2. The system according to claim 1, wherein extracting text information from the electronic files comprises executing optical character recognition on image data within the electronic files, and wherein the text information extracted from the optical character recognition is concatenated with text data directly parsed from non-image portions of the electronic files.

3. The system according to claim 2, wherein normalizing the extracted text information comprises applying at least character encoding normalization, removal of layout control characters, and whitespace collapsing to produce a normalized text string for each electronic file.

4. The system according to claim 1, wherein detecting subject-indicating expressions comprises applying a named entity recognition model to the normalized text information to identify text spans corresponding to named subjects, and wherein specifying speaking subjects comprises resolving co-references among the identified text spans using a co-reference resolution model.

5. The system according to claim 4, wherein extracting sentences corresponding to declarative statements for each speaking subject comprises identifying sentence boundaries in the normalized text information, associating each sentence with its nearest preceding subject-indicating expression, and retaining sentences that satisfy a declarative statement pattern defined in a classification rule set.

6. The system according to claim 1, wherein classifying the extracted sentences into category classifications comprises computing, for each extracted sentence, a classification probability distribution over a predefined set of categories using the trained classification model, and assigning the category classification corresponding to the highest probability as the category classification of the sentence.

7. The system according to claim 6, wherein classifying the extracted sentences into statement type classifications comprises applying a binary classification model to each extracted sentence to output a type label from a set comprising a policy type label and a promise type label.

8. The system according to claim 1, wherein generating comparison data in the list-comparable format comprises constructing a comparison table in which each row corresponds to a category classification, each column corresponds to a speaking subject, and each cell contains a text summary of the declarative statements of the corresponding speaking subject for the corresponding category classification.

9. The system according to claim 8, wherein the text summary of each cell is generated by constructing a summarization prompt sentence that includes the declarative statements for the corresponding speaking subject and category classification, transmitting the summarization prompt sentence to the generative model, and extracting the text summary from a response returned by the generative model.

10. The system according to claim 1, wherein generating the prompt sentence for the generative model comprises selecting a prompt template based on a query type indicator received from the terminal device, and inserting the structured data or the comparison data corresponding to the query into the selected prompt template.

11. The system according to claim 10, wherein the query type indicator specifies one of a comparison query type and a subject-specific query type, and wherein the prompt template selected for the comparison query type includes a multi-subject context block and the prompt template selected for the subject-specific query type includes a single-subject context block.

12. The system according to claim 1, wherein the structured data is indexed in the storage device by a composite key comprising a speaking subject identifier and a category classification identifier, and wherein retrieving declarative statements of a plurality of speaking subjects comprises executing a range query over the composite key index for a specified category classification identifier.

13. The system according to claim 12, wherein the circuitry is configured to maintain an inverted index mapping category classification keywords to structured data records, and to update the inverted index when new structured data is generated from received electronic files.

14. The system according to claim 1, wherein the circuitry is configured to receive correction data from the terminal device identifying an incorrectly classified sentence in the structured data, update the statement type classification or the category classification of the identified sentence based on the correction data, and retrain the trained classification model using the updated structured data.

15. The system according to claim 14, wherein retraining the trained classification model comprises collecting a set of updated structured data records that include correction data, computing a retraining loss based on the updated records, and performing a gradient update on parameters of the trained classification model.

16. The system according to claim 1, wherein the circuitry is configured to receive a natural-language query from the terminal device in addition to the category classification, extract search terms from the natural-language query using a keyword extraction model, retrieve structured data records matching both the category classification and the extracted search terms, and incorporate the retrieved records into the prompt sentence.

17. The system according to claim 16, wherein extracting search terms from the natural-language query comprises computing a term frequency-inverse document frequency score for each token in the natural-language query against the structured data corpus stored in the storage device, and selecting tokens whose score exceeds a term selection threshold as the search terms.

18. A system comprising:
circuitry configured to:
receive, via a communication interface coupled to a packet-switched network, electronic files from a terminal device, extract and normalize text information from the electronic files, and perform natural language processing on the normalized text information to detect speaking subjects and extract declarative statements per speaking subject;
classify the extracted declarative statements into category classifications and statement type classifications using a trained classification model, generate structured data representing associations between speaking subjects and category classifications, and store the structured data in a storage device; and
retrieve declarative statements for a specified category classification from the structured data in response to a query from the terminal device, generate comparison data in a list-comparable format, generate a prompt sentence based on the structured data or the comparison data, transmit the prompt sentence to a generative model via the communication interface, and transmit an answer received from the generative model to the terminal device.

19. The system according to claim 18, wherein the circuitry is configured to receive a natural-language query from the terminal device, extract search terms from the natural-language query, retrieve structured data records matching the search terms and the specified category classification, and incorporate the retrieved records into the prompt sentence for transmission to the generative model.

20. A method comprising:
receiving, via a communication interface coupled to a packet-switched network, electronic files from a terminal device, analyzing formats of the electronic files, extracting text information from the electronic files based on the analyzed formats, and normalizing the extracted text information by removing unnecessary symbols and whitespace;
performing natural language processing on the normalized text information to detect subject-indicating expressions, specify speaking subjects based on the detected expressions, and extract, for each speaking subject, sentences corresponding to declarative statements;
classifying the extracted sentences into category classifications and statement type classifications according to classification rules or a trained classification model, generating structured data representing association information between speaking subjects and category classifications, and storing the structured data in a storage device such that the structured data is searchable by speaking subject and by category classification;
retrieving, in response to a query from the terminal device specifying a category classification, declarative statements of a plurality of speaking subjects for the specified category classification from the structured data, and generating comparison data in a list-comparable format for transmission to the terminal device via the communication interface; and
generating a prompt sentence based on at least one of the structured data and the comparison data, transmitting the prompt sentence to a generative model via the communication interface, and transmitting an answer received from the generative model to the terminal device via the communication interface.
